(19) United States
(12) Patent Application Publication
(10) Pub. No.: US 2011/0009256 A1
(43) Pub. Date: Jan. 13, 2011

(54) NOVEL MICROPOROUS SILICATE MATERIALS AND METHODS FOR MAKING AND USING THE SAME

(75) Inventors: Michael Tsapatsis, Minneapolis, MN (US); Joaquin Coronas, Zaragoza (ES); Sunho Choi, Minneapolis, MN (US)

Correspondence Address: FISH & RICHARDSON P.C. (BO), P.O. BOX 1022, MINNEAPOLIS, MN, 55440-1022, US

(73) Assignee: REGENTS OF THE UNIVERSITY OF MINNESOTA, St. Paul, MN (US)

(21) Appl. No.: 12/668,731

(22) PCT Filed: Jul. 17, 2008
(86) PCT No.: PCT/US2008/008746

§ 371 Date: Sep. 21, 2010

Related U.S. Application Data
(60) Provisional application No. 60/950,258, filed on Jul. 17, 2007.

(51) Int. Cl. B01J 29/04

(52) U.S. Cl. 502/62; 502/60

(57) ABSTRACT

With an amino acid as a buffer, a method is disclosed for producing a proton-exchanged three-dimensional layered silicate material. Additional embodiments include a method for producing a swollen proton-exchanged three-dimensional layered silicate material. This new material is a result of reactive swelling which accompanies one or more major changes of the layer structure. The materials can be further processed such as with exfoliation. The materials may be combined with polymers to produce film membranes such as thin film porous membranes. The membranes are useful in separating gases and as absorbents.

This document claims the benefit of priority, under 35 U.S.C. Section 119(e), of U.S. Provisional Patent Application Ser. No. 60/950,258, entitled NOVEL MICROPOROUS SILICATE MATERIALS AND METHODS FOR MAKING AND USING SAME, filed on Jul. 17, 2007 (Attorney Docket No. 600.698PRV), the contents of which is incorporated by reference herein in its entirety.

### STATEMENT OF GOVERNMENT RIGHTS

This invention was made with support of the United States Government under National Science Foundation Contract CTS-0327811 and Department of Energy Contract DE-FG26-04NT42119. The Government has certain rights in this invention

### BACKGROUND

Interest in porous lamella solids, i.e., layered zeolite and related materials, has dramatically increased recently due to the discovery of new layered materials and new routes to modify existing lamella zeolites. Materials with nanoporous layers have structures intermediate between that of crystalline nanoporous frameworks (e.g., zeolites) and typical layered materials (e.g., clay minerals). Each nanoporous layer includes a porous network while the gallery between layers allows for intercalation, pillaring and exfoliation.

### SUMMARY

The inventors have determined there is a need for novel microporous silicate materials, which are disclosed herein. In one embodiment, with an amino acid as a buffer, the method comprises exchanging one or more cations from a location in between adjoining layers of a layered silicate material with one or more protons to produce a proton-exchanged layered silicate material, the proton-exchanged layered silicate material comprising at least two layers, each of the at least two layers including a plurality of tetrahedral SiO₄ units, each of the at least two layers further having a first plurality of channels extending from a top side of the layer to a bottom side of the layer, wherein each channel in the first plurality of channels is defined by an X-membered ring, where X is an integer and is the same for each channel, each of the at least two layers further including a second plurality of channels extending essentially parallel to the top side of the layer.

In one embodiment, proton exchange of AMH-3 using amino acid solutions results in AMH-3 materials that, while amorphous by X-ray diffraction, retain the original morphology of the crystalline particles. In a particular embodiment, adsorption analysis of proton-exchanged AMH-3 material indicates it possesses pores in the one to two nanometer-sized range and a surface area of almost 200 m²/g. In comparison, as-synthesized AMH-3 has a surface area of only about five (5) m²/g. Since most of the Na and Sr cations present in the proton-exchanged material are replaced by protons, this new adsorption capacity is likely due to porosity created from both the galleries and the 8 MR channels of the layered AMH-3 material. Similar results are expected with other layered silicate materials.

Embodiments further include a novel post-treatment procedure which yields, for the first time, swollen proton-exchanged layered silicate materials, which have been produced by reactive swelling. Such a result is surprising in that major structural modifications occur with the reactive swelling, rather than only minor structural modifications, as with intercalation. In one embodiment, the step of reactive swelling begins prior to completion of the proton exchange step.

Both the proton-exchanged materials and the materials produced by reactive swelling can be subject to further treatment, including exfoliation, pillaring, and so forth. Further characterization as to atomic positions within the proton-exchanged materials may also be performed.

In one embodiment, the proton-exchanged layered silicate is partially exfoliated to produce stacks of no more than ten (10) individual layers. In one embodiment, stacks of no more than ten (10) individual layers are combined with a polymer to produce a nanocomposite.

In one embodiment, the proton-exchanged materials are combined with a suitable polymer to provide a composite material. In one embodiment, the swollen materials are incorporated in a suitable polymer and cast in the form of a thin film, resulting in the mixed matrix nanocomposite membrane.

Thin film membranes described herein are useful for a variety of separation applications, such as sieves for separating hydrogen and carbon dioxide (e.g., in power plants at temperatures of approximately 200 to 300° C. and as membranes for gas and liquid separations.

In one embodiment, membranes other than substantially homogeneous (uniform) thin film (flat) membranes are produced, including, but not limited to, hollow fiber (cylindrical) membranes and asymmetric hollow fiber membranes having a thin skin over a porous sublayer.

### BRIEF DESCRIPTION OF THE DRAWINGS

FIG. 1A shows a cross-sectional view of an exemplary reactor useful in the hydrothermal synthesis of AMH-3.

FIG. 1B shows a schematic of AMH-3.

FIG. 1C shows a schematic of a nanocomposite membrane in an embodiment of the present invention.

FIG. 2 shows XRD diffraction patterns of (from bottom to top): simulated AMH-3, as-synthesized AMH-3, calcined AMH-3, Al-AMH-3 and K-AMH-3.

FIG. 3A shows an SEM image of non-purified AMH-3.

FIGS. 3B, 3C and 3D show SEM images of purified AMH-3.

FIG. 3E shows an SEM image of purified Al-AMH-3.

FIG. 3F shows an SEM image of purified K-AMH-3.

FIG. 4 shows XRD diffraction patterns of (from bottom to top): as-synthesized AMH-3 and AMH-3 exchanged at initial and final pH values of 7.8/8.3, 7.2/8.1, 6.8/7.9, 6.4/7.5 and 6/6.6 in embodiments of the present invention.

FIGS. 5A, 5B, 5C and 5D show SEM images of proton-exchanged AMH-3 in embodiments of the present invention.

FIG. 6A shows a TEM micrograph of as synthesized AMH-3, inset showing (100) electron diffraction pattern.

FIG. 6B shows a TEM micrograph of a proton-exchanged AMH-3 particle with a porous appearance in an embodiment of the present invention.

FIG. 6C shows a higher magnification TEM micrograph of FIG. 6B with an approximately two (2) nanometer (nm) pore size in an embodiment of the present invention.

FIG. 6D shows a TEM micrograph of a proton-exchanged AMH-3 particle viewed along the bc plane of the layers in an embodiment of the present invention.

FIG. 6E shows a proton-exchanged AMH-3 particle viewed along the plane of the layers in an embodiment of the present invention.

FIG. 7 shows N₂ isotherms of as-synthesized material (AMH-3), proton-exchanged AMH-3, and swollen AMH-3 in embodiments of the present invention.

FIG. 8A shows XRD patterns of AMH-3 swollen using different procedures in embodiments of the present invention.

FIG. 8B shows FT-IR spectra of swollen AMH-3 produced with reactive swelling in comparison to the FT-IR spectra of original AMH-3.

FIGS. 9A, 9B, 9C and 9D show SEM images of swollen AMH-3 produced with reactive swelling in embodiments of the present invention.

FIG. 10A shows an X-ray diffraction pattern and ²⁹Si solid-state MAS NMR spectra (inset) of original crystalline AMH-3.

FIG. 10B shows an X-ray diffraction pattern and ²⁹Si solid-state MAS NMR spectra (inset) of swollen AMH-3 in embodiments of the present invention.

FIG. 10C shows an SEM image of original AMH-3.

FIG. 10D shows an SEM image of swollen AMH-3 in an embodiment of the present invention.

FIGS. 10E and 10F show TEM images of swollen AMH-3 in embodiments of the present invention.

FIG. 11 shows TGA results of original AMH-3 and swollen AMH-3 in embodiments of the present invention.

FIG. 12A shows ²⁹Si solid-sate MAS-NMR spectra of original AMH-3.

FIG. 12B shows ²⁹Si solid-sate MAS-NMR spectra of swollen AMH-3 in an embodiment of the present invention.

FIG. 12C shows FT-IR spectra of original and swollen AMH-3 in an embodiment of the present invention.

FIG. 13 provides probable structure models for swollen AMH-3 projected along the a-axis and c-axis in embodiments of the present invention.

FIG. 14 shows XRD diffraction patterns of swollen AMH-3/polymer in an embodiment of the present invention.

FIG. 15A shows a schematic for synthesis of a nanocomposite membrane in an embodiment of the present invention.

FIG. 15B shows pore dimensions of original AMH-3 and swollen AMH-3 (Structure B) in an embodiment of the present invention.

FIG. 16A shows a cross-section TEM of a nanocomposite membrane in an embodiment of the present invention.

FIG. 16B shows two TEM images forming a cross-section of a nanocomposite membrane and tilted by 40 degrees with respect to each other in an embodiment of the present invention

FIG. 17A shows SAXS spectra of pure polybenzimidazole and the three (3) wt % swollen AMH-3 nanocomposite in an embodiment of the present invention.

FIG. 17B shows a cross-sectional TEM image of the three (3) wt % swollen AMH-3 nanocomposite in an embodiment of the present invention.

FIG. 17C shows hydrogen/carbon dioxide ideal selectivity at 35° C. as a function of hydrogen permeability (in Barrer) for pure PBI from a known source (PBI₁), pure PBI developed herein (PGI₂), PBI with dodecylamine (PBI₃), 14 wt % proton-exchanged AMH-3/PBI mixed matrix composites (P₁, P₂), three (3) wt % (S₁) and two (2) wt % (S₂) swollen AMH-3/PBI nanocomposites in embodiments of the present invention.

FIG. 17D shows hydrogen/carbon dioxide ideal selectivity at 100° C. as a function of hydrogen permeability (in Barrer) for pure PBI from a known source (PBI₁), pure PBI developed herein (PBI₂), PBI with dodecylamine (PBI₃), 14 wt % proton-exchanged AMH-3/PBI mixed matrix composites (P₁, P₂), three (3) wt % (S₁) and two (2) wt % (S₂) swollen AMH-3/PBI nanocomposites in embodiments of the present invention.

FIG. 17E shows hydrogen/carbon dioxide ideal selectivity at 200° C. as a function of hydrogen permeability (in Barrer) for pure PBI from a known source (PBI₁), pure PBI developed herein (PBI₂), PBI with dodecylamine (PBI₃), 14 wt % proton-exchanged AMH-3/PBI mixed matrix composites (P₁, P₂), three (3) wt % (S₁) and two (2) wt % (S₂) swollen AMH-3/PBI nanocomposites in embodiments of the present invention.

FIGS. 18A and 18B show TEM images of swollen AMH-3: after priming at 100° C. in embodiments of the present invention.

FIGS. 18C and 18D show TEM images of swollen AMH-3 after priming at room temperature in embodiments of the present invention.

FIG. 19 shows small angle neutron scattering (SANS) spectra of a dilute solution of PBI in DMAc (0.7 g of 7.5 wt % PBI solution in 5.31 g of DMAc) and swollen AMH-3 samples dispersed in dilute PBI solution at room temperature conditions, in which the amount of polymers were varied by 0.05, 0.1, 0.3, and 0.7 g, respectively, in embodiments of the present invention.

### DETAILED DESCRIPTION

In the following detailed description of embodiments of the invention, embodiments are described in sufficient detail to enable those skilled in the art to practice them, and it is to be understood that other embodiments may be utilized and that chemical and procedural changes may be made without departing from the spirit and scope of the present subject matter. The following detailed description is, therefore, not to be taken in a limiting sense, and the scope of embodiments of the present invention is defined only by the appended claims.

The Detailed Description that follows begins with a definition section followed by a brief overview of other attempts to produce proton-exchanged AMH-3, a description of the embodiments, examples and a brief conclusion.

### DEFINITIONS

As used herein, the term “AMH-3” or “Amherst-3” refers to a layered silicate comprising eight-membered rings and a gallery structure occupied by water molecules, strontium and sodium cations. AMH-3 has three-dimensional channels or pores comprised of eight-membered rings in the silicate layers, further containing cations (sodium and/or strontium ions) between adjacent layers as well as within the pores of the layers, wherein the three-dimensional channels include uniform crystalline pores oriented substantially perpendicular to uniform crystalline pores in a horizontal plane. The chemical formula of AMH-3 is as follows: Na₈Sr₈Si₃₂O₇₆.16H₂O. Further processing of AMH-3 allows the material to be useful in various applications.

As used herein, the term “swelling” without any further qualification or the term “conventional swelling” refers to the introduction of an ionic or non-ionic surfactant or one or more other guest molecules into the gallery space, which increases the thickness of the gallery. In contrast to “intercalation” or “reactive swelling” (defined below), there are no major and/or minor changes in the layer structure with conventional swelling.

As used herein, the term “intercalating” refers to a type of swelling which involves the introduction of an ionic or non-ionic surfactant or one or more other guest molecules into the gallery (space between the layers) of a host structure without any major structural changes in any layer of the host structure. The resulting product is an intercalated phase. Structural changes which occur include increased gallery spacing (i.e., thickness) and only minor changes of the layer structure. Minor changes include, for example, a change in bond angles and atomic positions with minimal or no corresponding change in atom connectivity.

As used herein, the term “reactive swelling” refers to a process which involves not only the introduction of one or more guest molecules into the gallery of a host structure to produce the minor structural changes associated with intercalation (as defined herein), but also one or more major structural changes in the layers of the host structure. The resulting product is a new material rather than an intercalated phase. Technically, therefore, such a process goes beyond “swelling” of a material, although for purposes of comparison with conventional swelling and intercalation, as defined above, the term “reactive swelling” is used herein. Major structural changes within the layer include formation of new bonds, breaking of bonds and/or changes to bond angles, as compared with the original host structure. As a result, connectivity between atoms within an individual layer is altered. A material produced by “reactive swelling” may be referred to herein as a “swollen material” or a “swollen proton-exchanged material,” a term which also references the proton exchange step, as defined below.

As used herein, the term “proton exchange” refers to exchange of ions in the gallery and/or layer with protons.

As used herein, the term “ion exchange” refers to exchange of ions in the gallery and/or layer with other ions, including an ionic surfactant.

### Background Discussion

Various other methods have been attempted to produce proton-exchanged AMH-3. However, such methods have not been successful, resulting either in complete dissolution of the AMH-3 or no change to the AMH-3. Specifically, addition of a quarternary alkylammonium cation (e.g., hexadecyltrimethylammonium bromide (CTAB) or dodecyltrimethylammonium bromide (DTAB)) to AMH-3 in the presence of tetrapropylammonium hydroxide (TPAOH) results in complete dissolution of the AMH-3. Addition of a quarternary alkylammonium cation (e.g., CTAB or DTAB) alone or addition of an ammonium salt of a primary amine, dodecylamine (DOA) to AMH-3 results in no changes of any type to the AMH-3. Specific details of these attempts are described below with cited references appearing at the end of this section:

### 1. Complete Dissolution of AMH-3 Using Intercalation of Quaternary Alkylammonium Cations in the Presence of Tetrapropylammonium Hydroxide and CTAB or DTAB as Surfactant

The swelling of AMH-3 was attempted with various quaternary alkylammonium cations in the presence of tetrapropylammonium hydroxide (TPAOH), using the recipes reported by Corma et al, for the swelling of zeolite precursor MCM-22(P). Firstly, 0.2 g of AMH-3 was added in 2.6 g of deionized water. The 29 wt % aqueous solution of CTAB was prepared by dissolving 4.05 g of CTAB in 9.9 g of deionized water. This solution was added into the previously made AMR-3 suspension along with 4.4 g of TPAOH. The pH of the mixture solution, containing a cationic surfactant (CTAB) and TPAOH, showed a very high pH of around 14. The mixture was refluxed for 16 hours at 80° C. as described by Corma et al. However, it was not possible to obtain a solid phase, resulting in the complete dissolution of AMH-3. Another cationic surfactant, DTAB, was tried, using the same procedure described above, but also resulted in the complete dissolution of AMH-3.

2. No Change to AMH-3 Using Intercalation with Quaternary Alkylammonium Cations

In order to prevent the complete dissolution of AMH-3 under high pH conditions used above, direct intercalation of quaternary alkylammonium cations (CTAB and DTAB) was tried without using TPAOH. Except for the absence of TPAOH, all other experimental conditions described above were unchanged. Although the complete dissolution of silicates was prevented, the structure of AMH-3 remained unchanged and further did not swell.

3. No Change to AMH-3 Using Intercalation with Ammonium Salt of Primary Amines

An additional attempt relied on the knowledge that non-porous layered silicates (clays) such as Na-montmorillonite have been known to be intercalated with ammonium salts of a primary amine. Based on the schemes reported by Bala et al., the ammonium salt of dodecylamine was used instead of quaternary alkylammonium cations. Next, 0.2 g of AMH-3 was dispersed in 25 ml of deionized water by vigorous stirring at room temperature. In order to make an aqueous solution of ammonium salt, for example, 2.1 g of dodecylamine was dissolved in 50 ml of deionized water and titrated by 0.4 g of hydrochloric acid. The solution was allowed to react for about an hour at 60° C. under vigorous stirring and transferred to the aqueous dispersion of AMH-3 drop wise. The mixture solution was further reacted at 60° C. for 12 hours under reflux with very vigorous stirring. After 12 hours of reaction, the product was centrifuged to separate the solids and rinsed with deionized water. The washing procedure was repeated four times to remove the residual amines from the particle surface. Following drying at room temperature for two days under air flow, about 0.1 g of a solid phase (white powder) was produced. In spite of different intercalating species from method 2, the final phase was again identical to the original AMH-3.

### DESCRIPTION OF THE EMBODIMENTS

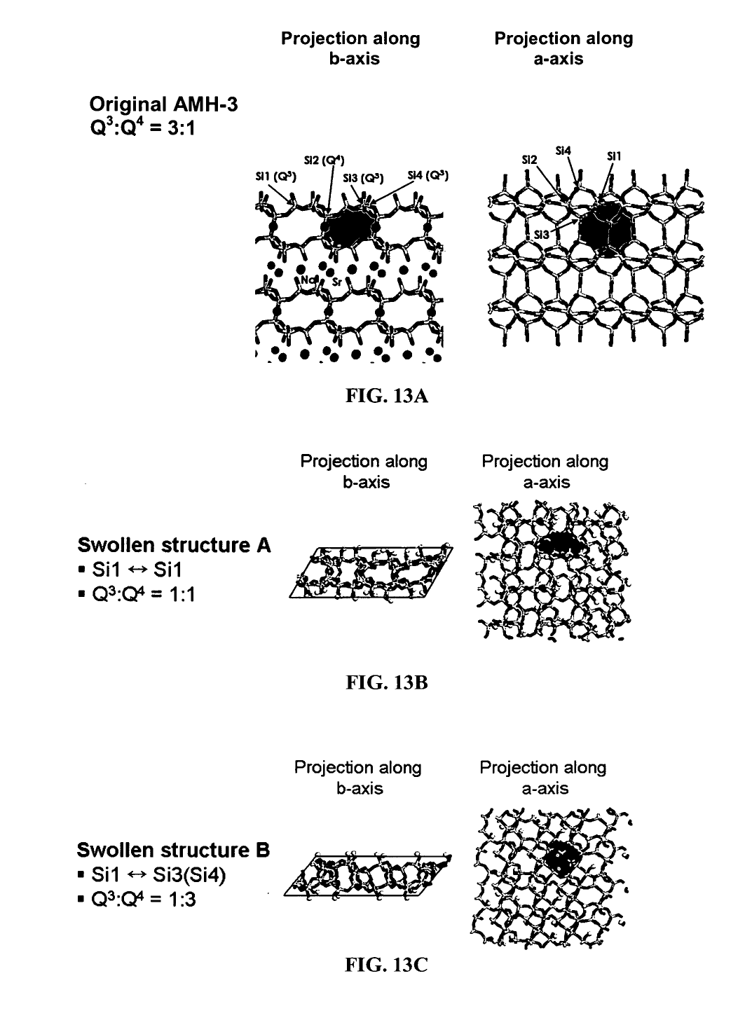

Embodiments of the invention include a method for making a proton-exchanged layered silicate material. In one embodiment, with an amino acid as a buffer, the method comprises exchanging one or more cations from in between adjoining layers of a layered silicate material with one or more protons to produce a proton-exchanged layered silicate material, the proton-exchanged layered silicate material comprising at least two layers, each of the at least two layers including a plurality of tetrahedral SiO₄ units, each of the at least two layers further having a first plurality of channels extending from a top side of the layer to a bottom side of the layer, wherein each channel in the first plurality of channels is defined by an X-membered ring, where X is an integer and is the same for each channel, each of the at least two layers further including a second plurality of channels extending essentially parallel to the top side of the layer. In one embodiment X=8 such that the layered silicate material is AMH-3 as defined herein. In other embodiments, X may equal 4, 5, 6 or 8, depending on whether the structure is an “A” type swollen structure or a “B” type swollen structure. (See FIG. 13). Specifically, X may equal 4, 6 or 8 for swollen structure “A” and X may equal 5, 6, or 8 for swollen structure “B.” The one or more protons may be from the amino acid, added acid of any type (e.g., HCl), added water, or combinations thereof.

Embodiments of the invention further include novel proton-exchanged layered silicate materials, novel swollen proton-exchanged layered silicate materials, further including novel exfoliated and pillared products and composite polymeric materials, further including novel thin film membranes. These silicate materials are three-dimensional with uniform or crystalline channels or pores perpendicular to the uniform or crystalline channels or pores in the horizontal layer.

In one embodiment, the one or more protons are exchanged with one or more strontium cations, one or more sodium cations, or a combination thereof, the one or more strontium and sodium cations located in the layered silicate material, i.e., the framework.

Various amino acids may be used as a buffer to provide protons for ionic exchange with the layered silicate material. However, addition of amines, which are usually not protonated, to layered silicate materials (e.g., AMH-3) will not provide the protons necessary to produce a proton-exchanged layered silicate material as in embodiments of the present invention. The use of slightly acidic amino acids for proton exchange is in contrast to conventional methods which are typically performed first under basic conditions using an ammonium cation for the exchange followed by acidification to low pH (i.e., lower than three (3)) for proton exchange.

In one embodiment, the amino acid has a pKa value of approximately six (6), although the invention is not so limited. In one embodiment, the amino acid with a pKa of six (6) is DL-histidine. It is also expected that other amino acids with pKa values greater than about four (4) up to less than about (7) may be useful herein, including, but not limited to, 1-methylhistidine, diiodotyrosine and glutamic acid. (See Dawson, R. M. C. et al, Data for Biochemical Research, Oxford, Clarendon Press (1959)).

In one embodiment, the proton-exchanged layered silicate material further contains a monovalent cation such as potassium or likely also cesium or lithium. In one embodiment, the proton-exchanged layered silicate material further contains an element having catalytic properties, such as aluminum.

In one embodiment, proton-exchanged AMH-3 may be prepared using an aqueous solution of amino acid as a buffer in order to provide protons to the system. For exemplary purposes, 0.2 M solution of DL-histidine may be used to protonate 0.2 g of AMH-3. In this embodiment, approximately 0.8 g of DL-histidine (>99 wt %, Fluka) can be dissolved in approximately 25 ml of deionized water at an elevated temperature, e.g., 60° C., under vigorous stirring until a transparent solution is obtained. The initial pH of prepared solution may be about 7.5. The solution is then cooled down to a suitable temperature, e.g., room temperature, under stirring before the addition of acid, e.g., concentrated hydrochloric acid. A few drops of acid are titrated drop wise until the pH of the solution is adjusted to the desired slightly acidic level, e.g., about six (6). In this embodiment, the proton exchange reaction is initiated by adding approximately 0.2 g of AMH-3 to the solution and completed after a suitable length of time, e.g., about four (4) hours, of vigorous stirring at room temperature. In this embodiment, the pH of the system is increased during the reaction and finally reaches a slightly acidic level of around 6.7 when completed, although the invention is not so limited. The product is centrifuged and rinsed with deionized water for several times, and dried at an elevated temperature for a suitable length of time, e.g., approximately 80° C. overnight, to obtain the white powder of proton-exchanged AMH-3.

In one embodiment, the proton exchange process is followed by a reactive swelling step using a suitable surfactant, i.e., swelling agent. In one embodiment, the reactive swelling step occurs prior to completion of the step of proton exchange step, thus relying on the slightly acidic pH provided by the amino acid in the proton exchange step. The reactive swelling step is in contrast to conventional swelling processes which rely on a cationic surfactant, such as an ammonium cation, an ammonium salt of an amine, or a combination thereof, which is added to the layered silicate for cationic exchange that results in conventional swelling (typically producing an intercalated phase). In one embodiment, the surfactant is a non-charged primary amine. In a particular embodiment, the method further comprises reactive swelling of the proton-exchanged layered silicate material with a non-charged primary amine to produce a swollen proton-exchanged layered silicate material.

In one embodiment, the layers of the original layered silicate material (prior to the proton exchange process) have a first structure and the layers of the swollen proton-exchanged layered silicate (after the proton exchange process and the reactive swelling step) have a second structure with the second structure having major structural differences resulting from the proton exchange process and the reactive swelling step, as compared with the first structure. In one embodiment, the major structural differences include broken bonds and/or new bonds and/or bond angle changes within the layers.

The surfactant may contain any suitable number of carbons, i.e., have any suitable chain lengths, as long as it can perform the intended function. In one embodiment, the surfactant contains at least 12 carbons. In one embodiment, the surfactant is dodecylamine, containing 12 carbons. In another embodiment, the surfactant may be tetradecylamine (C14), hexadecylamine (C16) or octadecylamine (C18). As the chain length of the surfactant increases, it is expected that the gallery height achieved will also increase.

In contrast, use of an ammonium cation (e.g., CTAB and DTAB), prior to the completion of the step of exchanging a cation, does not produce any type of swollen material or an intercalated material. The resulting material remains the proton-exchanged material.

In a specific embodiment, DL-Histidine and DOA are used in the reactive swelling step. For reactive swelling, two solutions, “A” and “B,” may be prepared separately. For exemplary purposes, solution “A” may be prepared with 2.06 g of dodecylamine (≧99.5%, Aldrich) dissolved in 50 ml of deionized water at an elevated temperature, e.g., 60° C., with slow stirring to minimize the occurrence of foaming. A homogeneous, turbid solution is obtained after a suitable stirring time, e.g., about 30 minutes, and kept under stirring at the elevated temperature until the titration into solution “B”. Again, for exemplary purposes, Solution “B” may be prepared by dissolving 0.78 g of DL-Histidine (>99 wt %, Fluka) in 25 ml of deionized water at an elevated temperature, e.g., 60° C., under vigorous stirring. After a transparent solution is obtained, it may be cooled, e.g., to room temperature, under stirring and a few drops of acid, such as concentrated hydrochloric acid, are added drop wise in order to adjust the pH of the solution into approximately six (6).

In this embodiment, the proton exchange reaction may be started by adding 0.2 g of as-made AMH-3 in solution “B” under vigorous stirring at room temperature. The exchange reaction may then be allowed to proceed until the desired pH is reached, e.g., 6.4, which corresponds to approximately 30 minutes of exchange reaction. It is also possible that slightly higher or lower pH's will work, including a pH as high as about 6.6 or as low as about 6.3. Once the desired pH is reached, solution “A” may be added drop wise to the mixture. The titration of solution “A” may be performed very slowly to prevent abrupt change of pH. The mixture solution is further reacted at an elevated temperature, such as about 60° C., under reflux with very vigorous stirring. After a suitable reaction time of up to 12 hours or more, the product is centrifuged to separate the solids and rinsed with deionized water. The washing procedure may be repeated any suitable number of times to remove the residual amines from the particle surface. Following drying at room temperature for a suitable length of time, e.g., two days, under air flow, swollen proton-exchanged AMH-3 (white powder) will result.

In one embodiment, the method further comprises exfoliating proton-exchanged layered silicate and/or swollen proton-exchanged layered silicate material to produce individual layers. The use of individual layers of nanometer thickness is generally more efficient in certain applications such as gas separation membranes, although the invention is not so limited. In one embodiment, the method further comprises exfoliating the proton-exchanged layered silicate material to produce stacks containing fewer individual layers than in the original layered silicate material. In one embodiment, the stacks contain up one (1), two (2), three (3), four (4) or five (5) individual layers, or more, up to ten (10) individual layers or more, or up to 1000 individual layers, but less than the number of layers in the original layered silicate material.

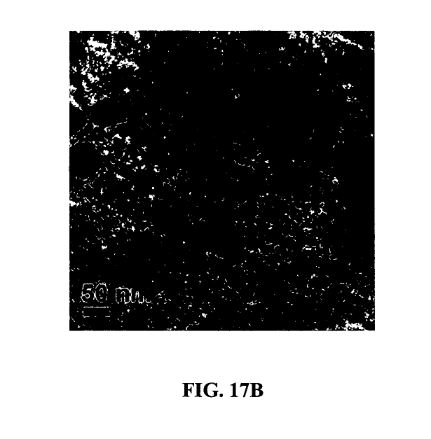

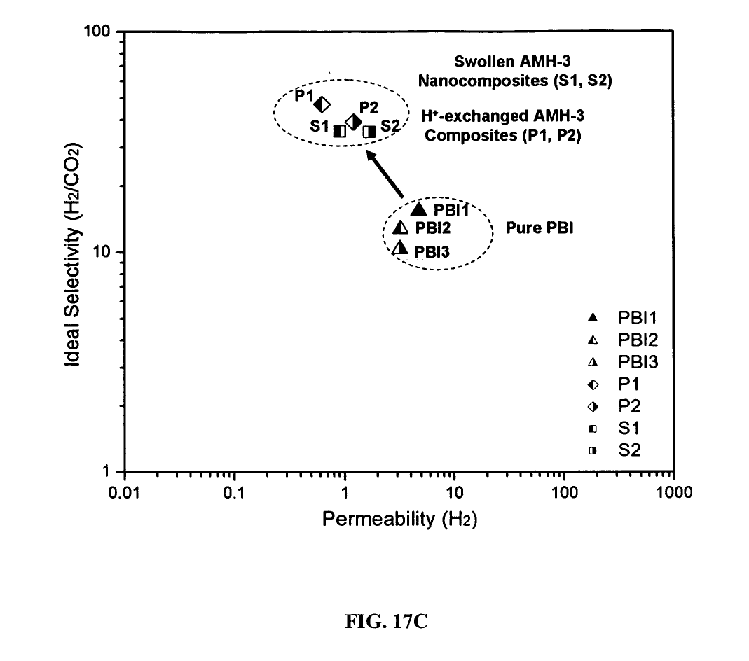

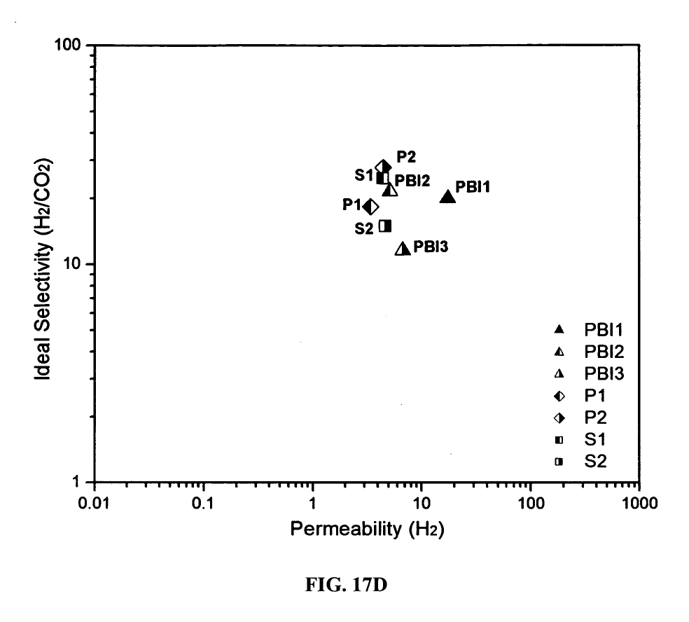

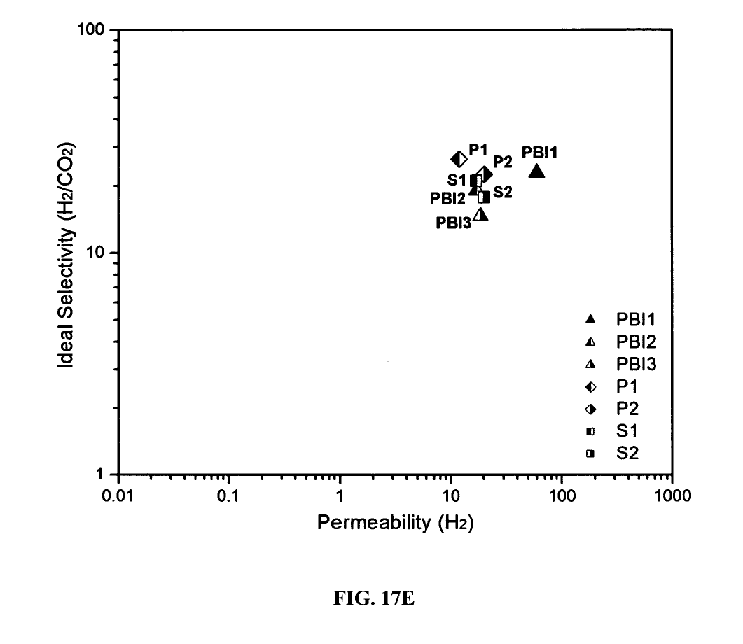

In one embodiment, the method further comprises combining individual layers or stacks of the proton-exchanged layered silicate and/or the exfoliated swollen proton-exchanged layered silicate material with a polymer as a selectivity enhancing additive. In one embodiment, the polymer has a hydrogen permeability which matches the hydrogen permeability of each individual layer. Without wishing to be bound by this proposed theory, it is thought that permeability mismatch between the polymer and layered silicate material may reduce performance. (See, for example, FIGS. 17D and 17E). Further testing will confirm the maximum acceptable permeability difference. Generally, if the permeability of the selective phase is too high relative to that of the matrix, neither permeating species is rejected by the selective phase, and the performance of the composite is dominated by the separation properties of the matrix. Likewise, if the permeability of the selective phase is too low relative to that of the matrix, both permeating species are effectively rejected by the selective phase and overall performance is again dictated by the transport properties of the matrix.

In one embodiment, the polymer is polybenzimidazole (PBI). In other embodiments the polymer is selected from the group of polybenzimidazole (PBI), polyimide (PI), polysulfone (PSF), Nafion® or any type of block copolymers (e.g., styrene-butadiene-styrene, styrene-isoprene-styrenein, styrene-vinyltrimethylsaline, and the like), or combinations thereof, although the invention is not so limited.

In one embodiment, the proton-exchanged layered silicate material or swollen proton-exchanged layered silicate material is dispersed in the polymer to form a substantially homogenous nanocomposite material.

In a specific embodiment, a two (2) wt % swollen proton-exchanged AMH-3 nanocomposite membrane may be produced by dispersing approximately 0.01 g of swollen proton-exchanged AMH-3 in approximately 5.3 g of dimethylacetamide (99.8%, Aldrich) followed by successive addition of approximately 0.7 g of dilute PBI (polybenzimidazole) solution (7.5 wt % PBI in 92.5 wt % dimethylacetamide). This first addition of a small amount of PBI is referred to as a “priming” step and is further explained in Example 3. After vigorous stirring for a sufficient time, e.g., about two hours, at a suitable temperature, such as about 373° K, 2.2 g of 20 wt % PBI solution may be added and further stirred at the same temperature for an additional length of time, e.g., two hours. The mixture may be cooled down to room temperature and sonicated for a suitable time, e.g., about one hour. The mixture may be poured on a glass plate and cast using a doctor's blade. The glass plate may be covered to prevent dust and heated in an oven at a suitable temperature and time, e.g., about 333° K for four (4) hours, to ensure the evaporation of solvents. Membranes of approximately 30 μm thickness may then be peeled off from the glass plate using small amount of deionized water. The membranes may then annealed by heating under vacuum in cyclic manner at a suitable temperature and number of cycles, e.g., between 323° K and 553° K for four times.

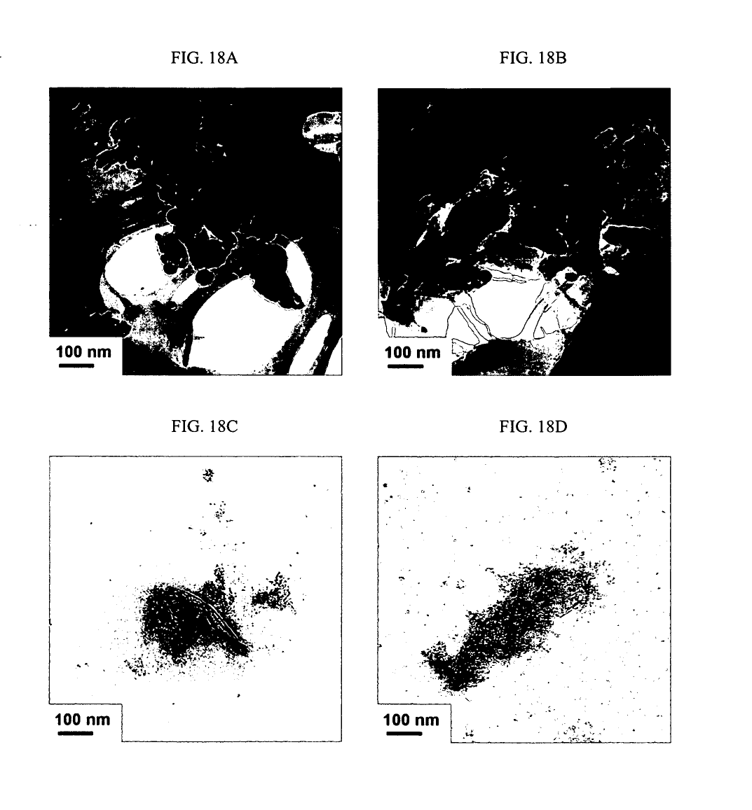

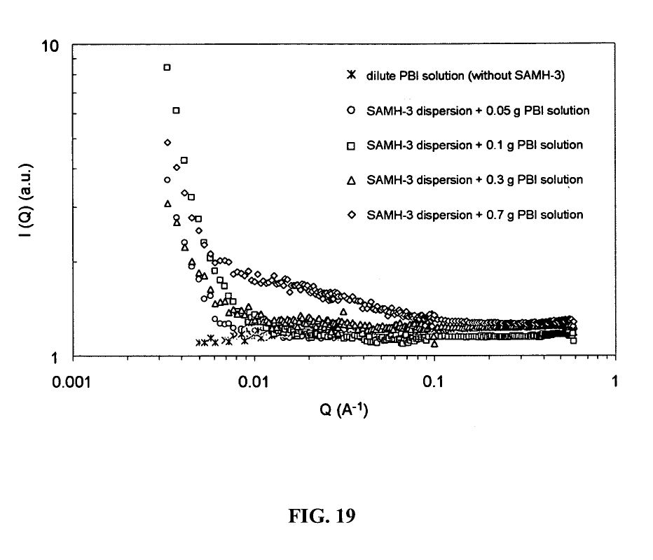

In one embodiment, novel swollen proton-exchanged AMH-3 materials described herein are prepared under room temperature conditions, i.e., about 20 to about 25° C. In one embodiment, the temperature is about 25° C. Therefore, in one embodiment room temperature swelling and/or “priming” reactions may also be used to produce satisfactory swollen proton-exchanged nanocomposite materials, without modifying other preparation conditions such as composition and time sequences of the procedures. See, for example, FIGS. 18C and D and FIG. 19. (Example 5). Temperatures above room temperature, such as any temperature greater than 25° C. up to the elevated temperatures tested herein (100° C.) or higher, may also be used. Excessively high temperatures, however, require additional energy consumption, and are not cost effective. Temperatures below room temperature conditions, such as below about 20° C., are not considered practical since additional cooling apparatus would be required. However, it is theoretically possible that the reaction could work at temperatures as low as about ten (10)° C. or even five (5)° C.

In one embodiment, the method further comprises casting the nanocomposite material on a surface to form a thin film membrane. In one embodiment, the nanocomposite material is cast on the surface with a suitable solvent. Generally any type of solvent known to be compatible with a particular polymer will work. Some of the example systems include, but are not limited to polyimide using tetrahydrofuran (THF), N,N-dimethylacetamide (DMAc), N-methylpyrrolidone (NMP), N,N-dimethylformamide (DMF) or dimethylsulfoxide (DMSO) as a solvent, polysulfone in THF or dichloromethane, Nafion® in DMAc or DMF, and various block copolymers such as styrene-butadiene-styrene, styrene-isoprene-styrenein, styrene-vinyltrimethylsilane using THF, toluene, or cyclohexane.

Certain polymers are not soluble or only partially soluble in common solvents. For example, PBI is chemically resistant to many organic solvents, but shows limited solubility in N,N-dimethylacetamide (DMAc), although the invention is not so limited. Other possible solvents include concentrated sulfuric acid and DMAc and THF. Use of a high-pressure vessel and/or high temperatures for PBI or any polymer is known to increase solubility as is known in the art.

In one embodiment, the method further comprises pillaring the swollen proton-exchanged layered silicate material to produce a pillared material, by the hydrolysis of tetraethylorthosilicate (TEOS) or using other pillaring agents based on the oxides of transition metals such as Al, Ti, Cr, etc. These pillaring agents, when mixed with the suspension of swollen precursor, can be introduced into the gallery space that is partly filled with surfactants such as quaternary alkylammoniums or amines, resulting in a material co-intercalated by surfactants and pillaring agents. Surfactant molecules are removed during the calcination process, leaving thermally-stable inorganic pillars in the interlayer space. The void space produced after surfactant removal leads to the mesoporous characteristics of pillared materials.

Embodiments of the invention further include products produced by any of the methods described herein. Such products include, but are not limited to a product comprising at least one layer of a proton-exchanged layered silicate material, each layer including a plurality of tetrahedral SiO4 units and a first plurality of channels extending from a top side of the layer to a bottom side of the at least one layer, wherein each channel in the first plurality of channels is defined by an X-membered ring, where X is an integer and is the same for each channel, the at least one layer further including a second plurality of channels extending essentially parallel to the top side of the at least one layer. In one embodiment, the product has more than one layer. In one embodiment X=8. In one embodiment, the product further comprises either a monovalent cation as discussed herein or an element having catalytic properties.

Embodiments of the invention further include a product comprising at least one layer of a swollen proton-exchanged layered silicate material, each layer including a plurality of tetrahedral SiO4 units and a first plurality of channels extending from a top side of the layer to a bottom side of the layer, wherein each channel in the first plurality of channels is defined by an X-membered ring, where X is an integer and is the same for each channel, the at least one layer further including a second plurality of channels extending essentially parallel to the top side of the at least one layer. In one embodiment, the product has more than one layer.

In one embodiment, the swollen proton-exchanged layer has improved porosity as compared with the starting material, e.g., AMH-3, which does not have a pore volume accessible to nitrogen (standard method for determining porosity). It is known that the N2 adsorption at 77 K for as-synthesized AMH-3 and other 8MR zeolites is minimal. This is in contrast to the novel swollen proton-exchanged AMH-3 material disclosed herein, which possesses a micropore volume accessible to nitrogen.

Embodiments of the invention further include a product comprising a pillared microporous silicate material which includes a swollen proton-exchanged layered silicate material or a proton-exchanged layered silicate material. In one embodiment, the pillared silicate material is a pillared microporous/mesoporous silicate material containing at least two microporous silicate layers, wherein silica pillars located between the at least two microporous silicate layers create mesoporosity and each of the at least two microporous silicate layers includes a plurality of tetrahedral SiO4 units and a first plurality of channels extending from a top side of each layer to a bottom side of each layer, wherein each channel in the first plurality of channels is defined by an X-membered ring, wherein X is an integer and is the same for each channel, each of the at least two microporous silicate layers further including a second plurality of channels extending essentially parallel to the top side of each layer.

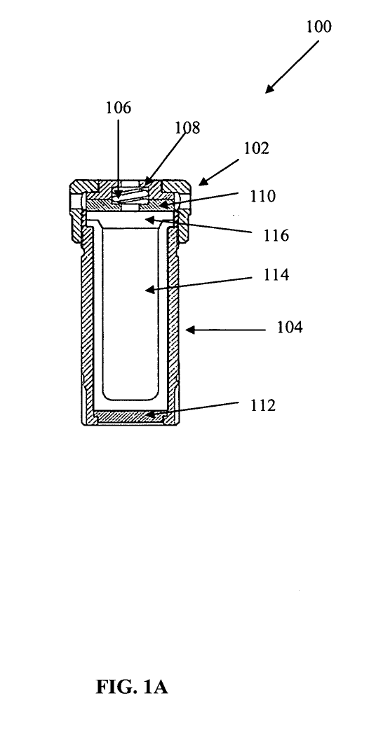

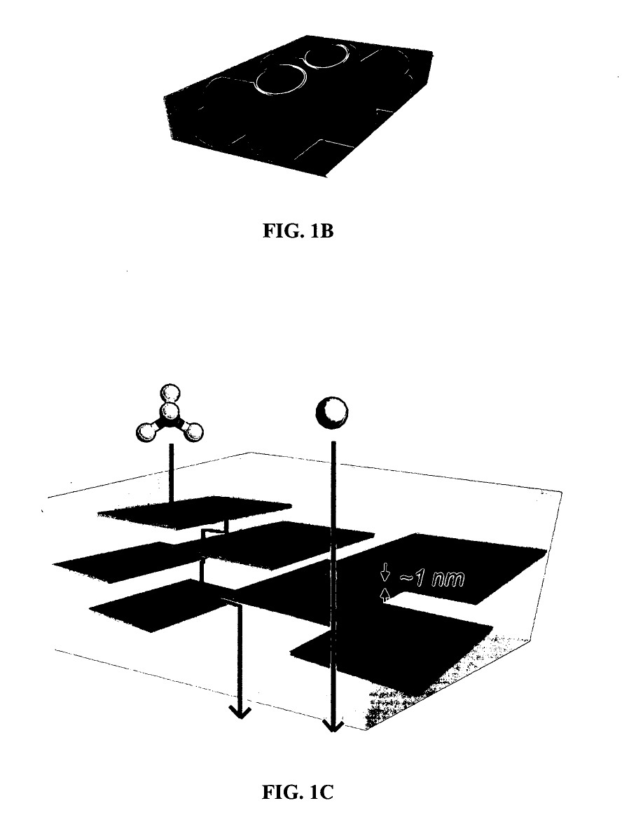

Additional products include composite materials comprising any of the aforementioned non-pillared products in combination with a polymer. Additional products further include porous membranes containing any of the aforementioned products. A nanocomposite membrane for gas separation involves the incorporation of selective phases to improve the performance of polymeric membranes while preserving the advantages of the original polymer. The polymer matrix provides processability, mechanical stability and low cost, while the nanoporous layers possess molecular sieving ability, thermal stability, although at a higher cost. Ideally, the nanoscale molecular sieves are dispersed as much as possible. (See FIG. 1C for a schematic of a nanocomposite membrane).

The resulting products are useful for any number of applications as is known in the art. In one embodiment, a thin film membrane having a substantially homogenous nanocomposite material comprising a polymer and a swollen proton-exchanged layered silicate material or a polymer and a proton-exchanged layered silicate material is used to separate gases, as an adsorbent for gas or liquid separations.

The invention will be further described by reference to the following examples, which are offered to further illustrate various embodiments of the present invention. It should be understood, however, that many variations and modifications may be made while remaining within the scope of the present invention.

### Example 1

### Synthesis of AMH-3

The hydrothermal synthesis of AMH-3 is known in the art. The process was carried out at 200° C. for three (3) days using the following molar composition: 1 TiO₂: 10 SiO₂: 2 SrCl₂: 14 NaOH : 675H₂O. (See also S. Nair, Z. Chowdhuri, I. Peral, D. A. Neumann, L.C. Dickinson, G. Tompsett, H. K. Jeong, M. Tsapatsis, Phys. Rev. B 2005, 71, 104301-1-8). (It is also possible to carry out the synthesis for more than three (3) days).

The synthesis took place in a standard Parr Acid Digestion Bomb Model No. 4744 made by Parr Instrument Company, having offices in Moline, Ill., although any suitable conventional reactor may be used for this process. A cross-sectional view of an exemplary reactor 100 is shown in FIG. 1A. The reactor 100 is comprised of a screw cap 102 and a metallic reactor body 104. The screw cap 102 includes a spring 106, a pressure disc 108 and a disc system 110 (comprised of a rupture disc stacked on top of a corrosion disc) which serve to keep the reactor properly sealed during operation. The reactor body 104 includes a bottom disc 112 and a liner body 114 having a liner cap 116. The reactants are placed inside the liner body. Both the liner body 114 and liner cap 116 are made from an inert material, such as Teflon®. The metallic reactor body 104 and bottom disc 112 may be made from stainless steel. The bottom disc 112 is used to close bottom openings (not shown) present in the reactor body 104.

The resulting crystalline AMH-3 (nanoporous layered silicate with three-dimensional eight-membered ring (8 MR)) is shown schematically in FIG. 1B. (The projection of the three-dimensional AMH-3 along the a-axis and c-axis is discussed in Example 2 and shown in FIG. 13A, FIG. 13B and FIG. 13C, in comparison to projections along the a-axis and c-axis for the novel swollen material produced herein).

Similar compositions were prepared to synthesize at the same conditions AMH-3 samples containing Al and K: 1.25 TiO₂: 0.1 Al₂O₃: 10 SiO₂: 2 SrCl₂: 14 NaOH : 675H₂O and 1 TiO₂: 10 SiO₂: 2 SrCl₂: 7.8 NaOH : 5.5 KOH: 675 H₂O, respectively. In all syntheses crystalline AMH-3 was obtained along with colloidal amorphous material (approximately 50/50) which was separated to yield pure AMH-3. To purify AMH-3, the content of one autoclave was diluted with deionized water and kept for 1 h in an ultrasonic bath, then the suspension is decanted and the sediment washed again with deionized water, so that after 5 min new sediment was obtained. This last procedure was repeated five (5) times to produce, after recovering the solids and drying overnight at 80° C., 0.6-0.8 g of pure AMH-3 crystals. Al-AMH-3 was purified after the solids were rinsed with deionized water, centrifuged and dried. This leads to increased difficulty in removal all the amorphous material.

Some of the samples prepared were proton-exchanged at room temperature for times ranging from 15 min to 4 h. At the end of these treatments the samples were washed with deionized water and dried overnight at 80° C.

XRD (X-Ray Diffraction) diffractograms were obtained using a Siemens D-5005 (CuKα, λ=1.5418 Å). SEM measurements were performed using a Jeol JSM-6500 SEM (Scanning Electron Microscope) working at 5 kV. TEM images were obtained with a FEI Technai T12 transmission electron microscope operating at 120 kV. The N₂ isotherm and the BET surface area were measured with an Autosorb-1 from Quantachrome, where the samples were degassed overnight at 350° C. Chemical analysis was carried out using inductively coupled plasma (ICP) analysis. (See Table 1 below).

### Results and Discussion of AMH-3 Synthesis

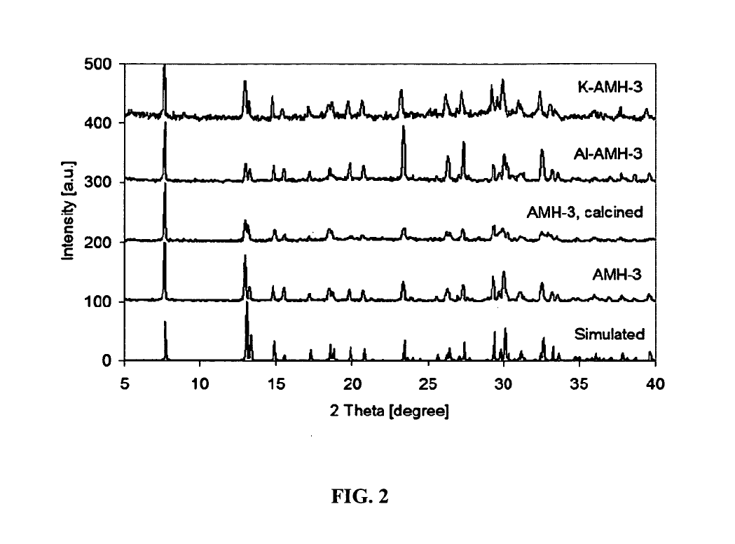

FIG. 2 shows that the solids prepared from any of the three compositions described above have intensities at the same 2-theta values present in the simulated pattern obtained by PowderCell for Windows (PCW) version 2.4. W. Kraus and G. Nolze. Federal Institute for Materials Research and Testing, Rudower Chaussee, 5, 12489 Berlin (Germany), using unit cell parameters and the atomic coordinates previously reported for AMH-3. After calcination for 6 h at 500° C. some peaks merge, although the XRD pattern still agreed well with the simulated one.

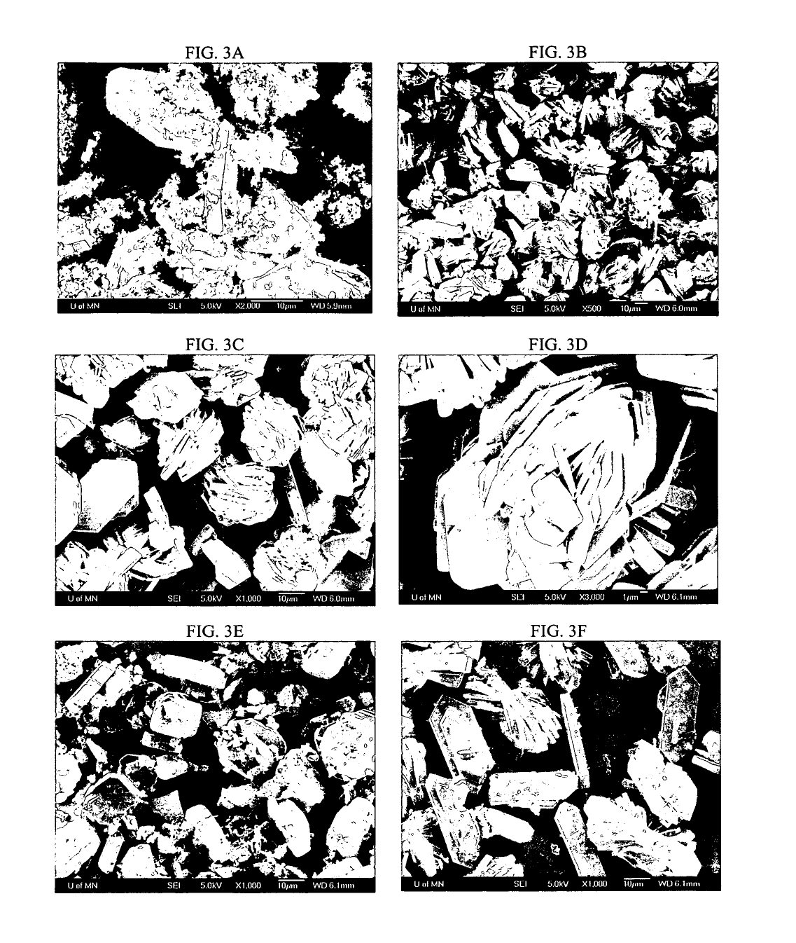

Before purification, the synthesis product had appreciable amounts of amorphous impurities, as can be seen in FIG. 3A. Titanium species are critical for the formation of AMH-3, although the material itself does not contain titanium, as a consequence some of the titanium is in the amorphous material surrounding AMH-3 crystals, as shown by ICP analysis (see “amorphous” sample in Table 1 below). In Table 1 the theoretical composition was calculated from the already published formula for AMH-3: Na₈Sr₈Si₃₂O₇₆.16H₂O. The compositions for the as-synthesized material prepared here and the proton-exchanged AMH-3 are also listed (discussed later). FIGS. 3B, 3C and 3D correspond to the material after purification, while FIGS. 3E and 3F show how the morphology of the crystals can be different if the chemical composition of the starting gel is changed. AMH-3 crystals from the regular synthesis possessed a coffin-shape having a lot of twins, while Al-AMH-3 ones seem to be more like squares, while K-AMH-3 crystals are longer.

TABLE 1
Composition (wt %) of some selected samples using ICP analysis

| Sample | Si | Na | Sr | Ti |
|---|---|---|---|---|
| Theoretical | 27.3 | 5.59 | 21.3 | 0 |
| AMH-3 | 26.7 | 4.76 | 20.3 | — |
| Amorphous | 20.9 | — | — | 9.09 |
| H-exchanged AMH-3 | 34.3 | 0.72 | 3.13 | — |

### Synthesis of Proton-Exchanged AMH-3

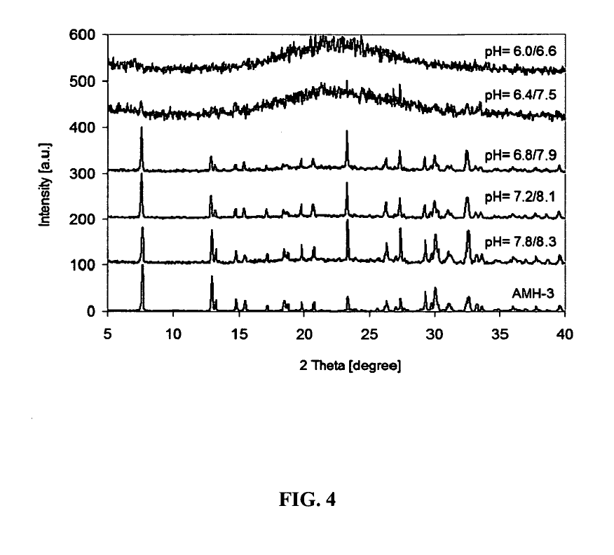

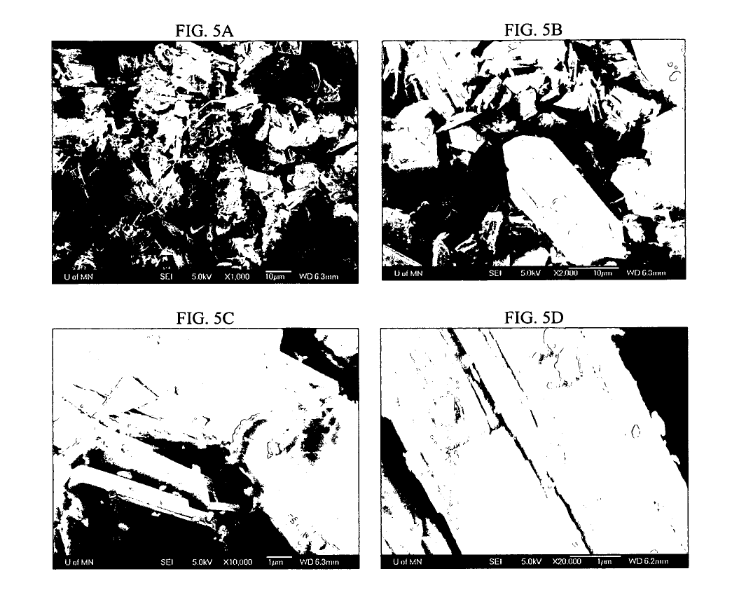

FIG. 4 shows the XRD patterns for several AMH-3 samples exchanged for 4 h at room temperature. From the top to the bottom of the FIG. 4, the initial pH of the solution was adjusted with concentrated hydrochloric acid from 6.0 to 7.8. The second value of pH given for each diffractogram in FIG. 4 corresponds to the final pH of the solution. The results indicate that at an initial pH lower than or equal to 6.4 AMH-3 becomes XRD-amorphous, even if at an initial pH of 6.8 changes in the XRD pattern are evident. The conditions of mild pH used in the proton exchange of AMH-3 results in a material that appears amorphous by XRD. However, the SEM images (FIGS. 5A-5D) show that the morphology of the as-synthesized AMH-3 is essentially preserved. This result is quite surprising. Further, from high magnification SEM images it is possible to distinguish slit-cracks that run parallel to the bc planes of the typical coffin-shape of the AMH-3 morphology. The size of these slits is in the nanometric range.

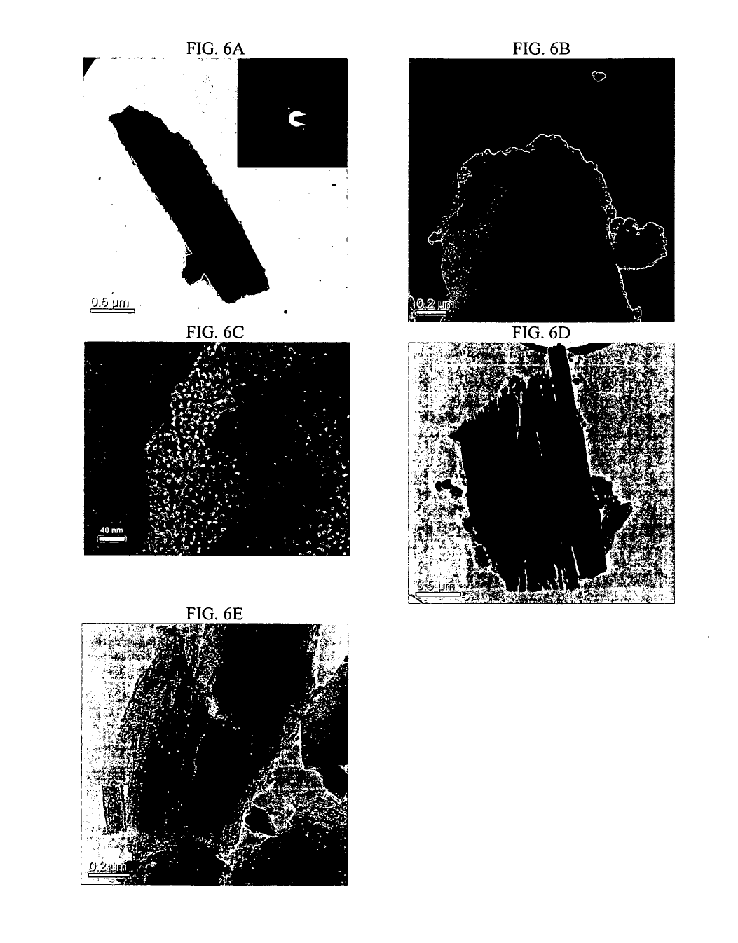

Analysis of TEM micrographs of proton-exchanged AMH-3 shows that the particles contain pores. This porous appearance, characteristic of the proton-exchanged particles, was not observed in AMH-3. Also, electron diffraction, which was observed in as-synthesized AMH-3, was not present in the proton-exchanged samples in agreement with the previous XRD results. This is shown in FIGS. 6A, 6B and 6C. In agreement with the SEM, it was noted that when viewed along the bc plane of the layers the crystals show preferential cracking in the direction of these planes (see FIG. 6D). FIG. 6E illustrates that, when viewed along this direction, the contrast in TEM also indicates that some directionality in the structure is maintained. That is, though the 3-D crystallinity is lost as evidenced by X-ray and electron diffraction, some vestige of lamellar character is retained upon proton exchange.

AMH-3 contains composite Na—O/Sr—O octahedral sheets in between its silicate layers, being the Sr:Na molar ratio of two (2). Half of the Na cations are in these layers, while the others are occluded in the pore space (8 MR pores) of the silicate layers. The proton-exchanged material produced herein, in which most of the Na and Sr cations have been replaced in the galleries (and in the 8 MR in the case of Na) by protons, as the ICP analysis indicates (see Table 1), has enough space to permit the N₂ adsorption.

FIG. 7 shows N₂ isotherms (77° K) for as-made, proton-exchanged and swollen AMH-3, respectively. The as-synthesized material shows very little nitrogen adsorption, consistent with a classification of nonporous materials according to IUPAC convention. Similar to other 8 MR zeolites such as analcime, this material shows almost no porosity to N₂ adsorption due to the small size of 8 MR apertures, and possibly due to pore blocking by intra and interlayer cations. Conversely, the proton-exchanged AMH-3 reveals significant adsorption at low pressure, as well as a hysteresis loop. This result indicates that the adsorption behavior of proton-exchanged material is consistent with that of a material containing micro and meso pores. The shapes of the isotherms obtained from swollen AMH-3 are qualitatively similar to that of the proton-exchanged material, while the amount of adsorbed nitrogen increases as the temperature of degassing increases. Increase of the adsorption capacity along with that of the outgassing temperature is possibly attributed to the extraction of interlayer amines at elevated temperatures, resulting in an increase in the area available for nitrogen adsorption. The highest amount of nitrogen adsorption is obtained for a calcined swollen AMH-3 sample.

### Example 2

### Preliminary Synthesis of Swollen AMH-3

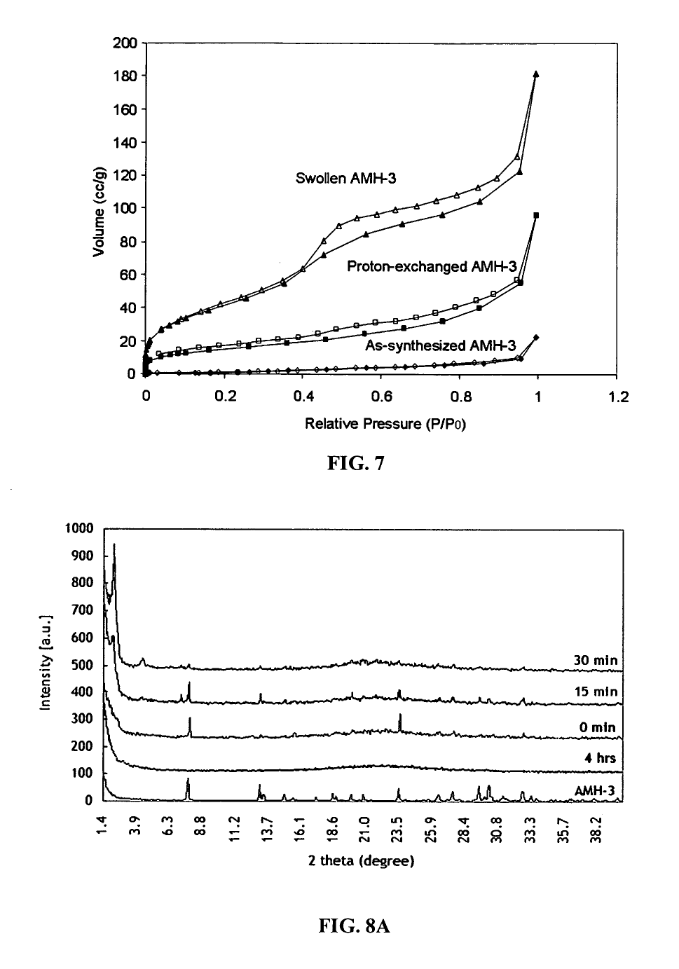

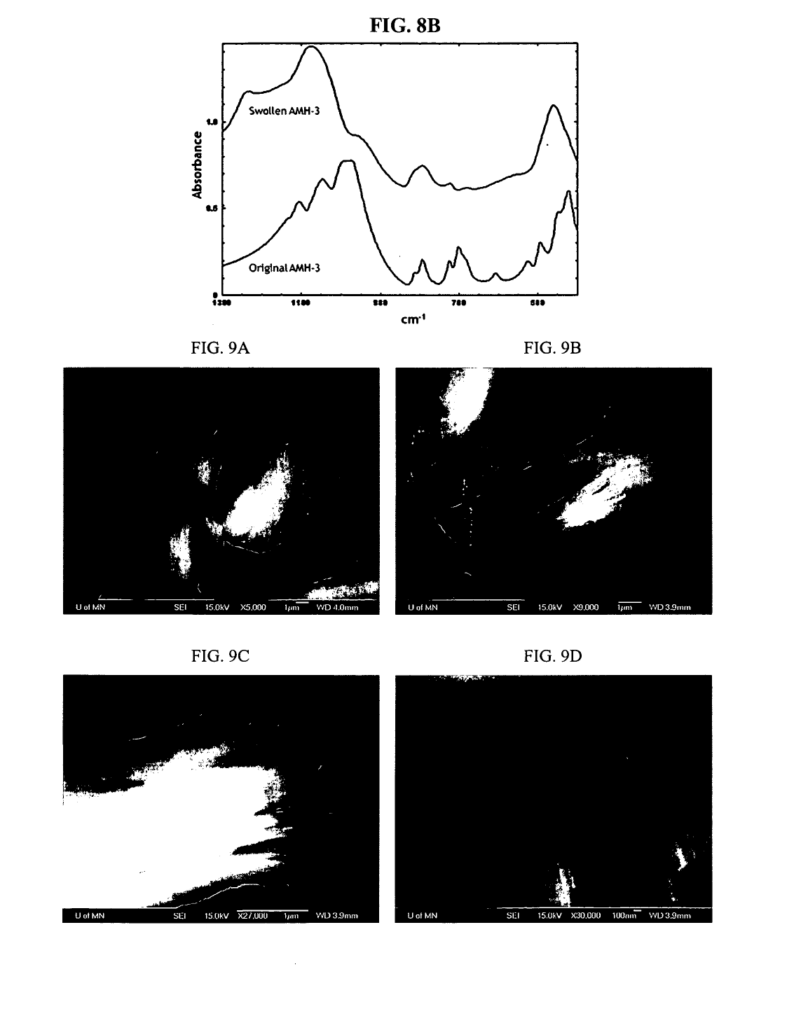

FIG. 8A shows the results of a series of experiments carried out by adding a surfactant solution after 0, 15, 30, and 240 minutes intervals. If surfactant was added after 15 minutes, the evidence of a swollen structure started to appear by means of new peaks around 2θ=2.1°, which corresponds to approximately 41 Å of interlayer spacing. However, the relative intensity of (100) peaks from original AMH-3 and new structure indicate that the swelling is still insufficient. The optimal condition for the swelling of AMH-3 was achieved when ionic exchange (originally assumed to be intercalation) was retarded further. In addition to the strong (100) peak at 2.14°, the peaks from (200) and (300) become evident at 4.29° and 6.43°, respectively. The basal spacing undergoes about 30 Å increase from 11.4 Å of original AMH-3 to 41.3 Å of the swollen AMH-3.

For the preliminary characterization of the swollen AMH-3, X-Ray Diffraction and Scanning Electron Microscopy was used. The XRD patterns were obtained using a Siemens D-5005 (CuKα λ=1.5418 Å) and the SEM micrographs were taken from a JEOL JSM-6500 working at 15 kV. The SEM micrographs (FIGS. 9A-9D) provide evidence of swollen AMH-3 produced with reactive swelling. In contrast to the proton-exchanged AMH-3, which preserves the morphology of the as-synthesized AMH-3 (See FIGS. 5A-5D), the SEM images of swollen AMH-3 in FIGS. 9A-9D look quite different, revealing thin layers along the crystal sides. The major structural changes in swollen AMH-3 as compared to the original AMH-3 becomes more evident in the higher magnification images, which reveal the separated layers parallel to the (100) planes of AMH-3.

### Synthesis of Swollen AMH-3 Using Reactive Swelling

The reactive swelling of AMH-3 was carried out by the sequential process comprising proton exchange and reactive swelling. The swollen derivative of AMH-3 was prepared by reactive swelling of primary amine molecules (dodecylamine) prior to completion of the proton exchange (described in Example 1) in the presence of amino acid. In this procedure an aqueous solution of DL-Histidine was employed as both a buffer and source of protons to exchange the strontium and sodium cations in the original structure. The initial pH was adjusted to be six (6) by addition of hydrochloric acid. The proton exchange reaction was allowed to proceed until the pH reached approximately 6.4 before adding the aqueous solution of dodecylamine. The swollen AMH-3 was obtained after twelve hours of reaction at 60° C.

For swelling, two solutions, A and B, were first prepared separately. To prepare solution A, 2.061 g of Dodecylamine (≧99.5%, Aldrich) was dissolved in 50 ml of deionized water at 60° C. with slow stirring to minimize the occurrence of foaming. A homogeneous, turbid solution was obtained after 30 minutes of stirring and kept under stirring at 60° C. until the titration into solution B. Solution B was prepared by dissolving 0.776 g of DL-Histidine (>99 wt %, Fluka) in 25 ml of deionized water at 60° C. under vigorous stirring. After a transparent solution was obtained, it was cooled down to room temperature under stirring and a few drops of concentrated hydrochloric acid were added drop wise in order to adjust the pH of the solution at 6.0. The proton exchange of AMH-3 was started by adding 0.2 g of as-made AMH-3 in solution B under vigorous stirring at room temperature. After 35 minutes of stirring, solution A was added drop-wise. The titration of solution A was performed very slowly to prevent abrupt changes of pH. The mixture solution was further reacted at 60° C. under reflux with very vigorous stirring. After 12 hours of reaction, the product was centrifuged to separate the solids and rinsed with deionized water. The washing procedure was repeated four times to remove the residual amines from the particle surface. Following drying at room temperature for two days under air flow, about 0.1 g of swollen AMH-3 (white powder) was produced.

The emergence of a swollen material was monitored by various characterization techniques including X-ray diffraction (XRD), ²⁹Si MAS NMR, IR spectroscopy, scanning (SEM) and transmission (TEM) electron microscopy as described and shown herein.

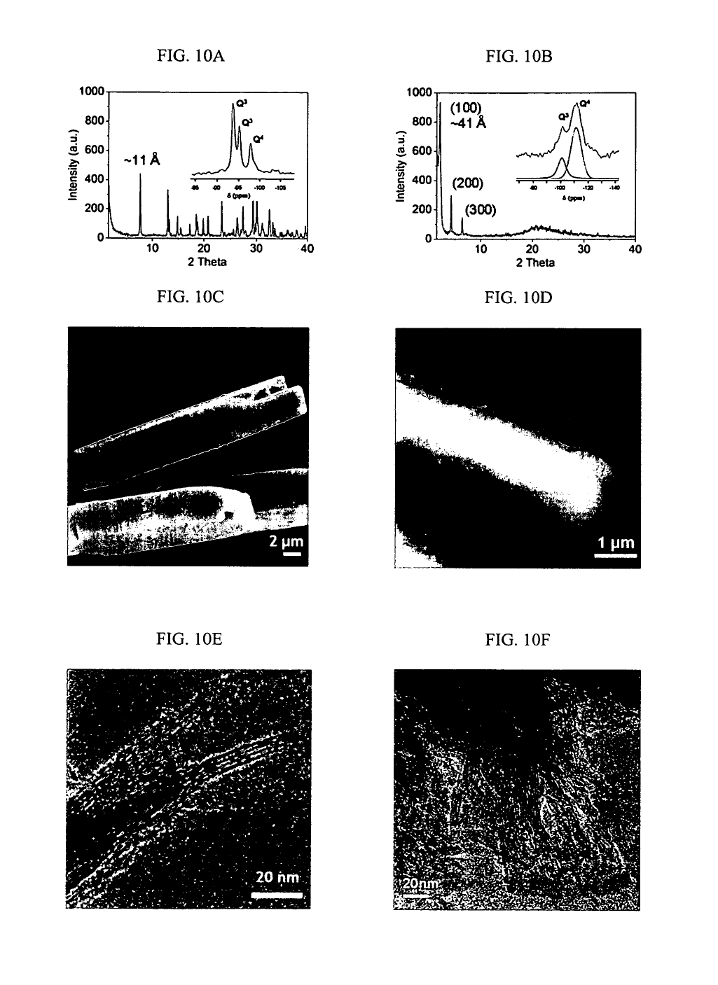

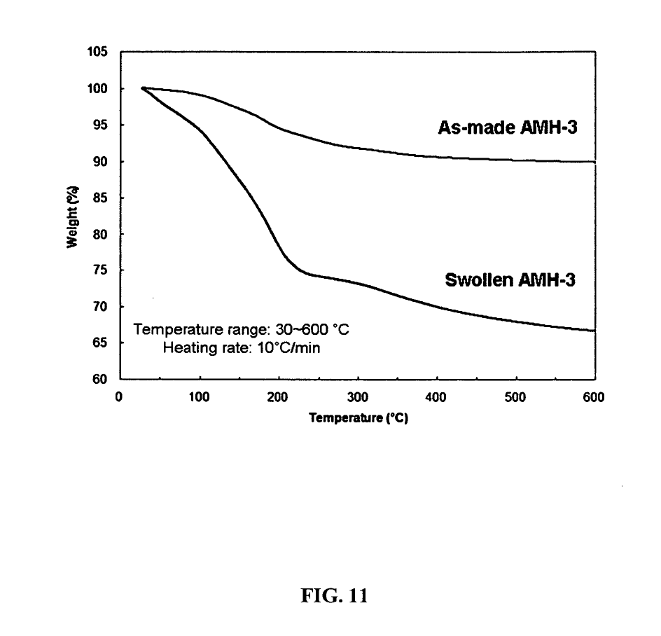

The unit cell of original AMH-3 includes two microporous layers and two gallery spaces which are aligned along the [100] crystallographic direction. The first XRD peak at 2θ≈7.75° is the (200) reflection of the AMH-3 structure (FIG. 10A). The corresponding basal spacing of approximately 11.4 Å is the sum of a layer thickness and a gallery height. The layered characteristics of swollen AMH-3 are revealed by a series of new peaks shown at 2θ≈2.14°, 4.29° and 6.43° indexed as (100), (200), and (300), respectively (FIG. 10B). From these peaks, the basal spacing of swollen AMH-3 is calculated as approximately 41.3 Å. It suggests that occupancy from dodecylamine molecules results in significant increase of the gallery height. The basal spacing of swollen AMH-3 is quite close to that of swollen magadiite, a material with comparable layer thickness with AMH-3, intercalated by the same surfactant. Considering the diameter (approximately 3.2 Å) and the length (approximately 14.9 Å) of a dodecylamine molecule, it appears that the long-chain surfactant adapts a bilayer configuration within the gallery space.

Results from TGA analysis shown in FIG. 11 suggest that the amount of interlayer dodecylamine corresponds to approximately 20 wt % of the swollen material. As shown in FIG. 11, weight loss of the original AMH-3 was 10.1% while weight loss of the swollen AMH-3 was 33.2%.

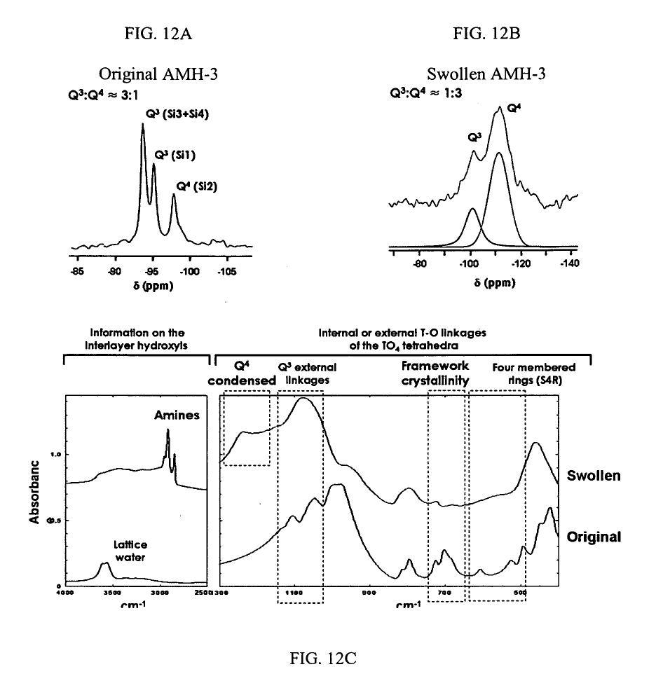

Structural changes involving different SiO₄ connectivity that occurred during the swelling process were also investigated by ²⁹Si MAS NMR. (See FIGS. 12A and 12B). Three resonances at −89.4, −90.8, and −93.5 ppm from the original crystalline AMH-3 were previously assigned to Q³ (Si3+Si4), Q³ (Si1), and Q⁴ (Si2) species, respectively (FIG. 10a, inset). These chemical shifts are lower than those in typical layered silicates, implying smaller Si—O—Si angles in the AMH-3 structure as corroborated by the crystal structure solved from X-ray diffraction data.

The NMR spectra of the swollen material (FIG. 10B, inset) are quite different from those of original AMH-3 but similar to the chemical shifts found in protonated layered silicate such as H⁺-magadiite. The swollen material exhibited two strong resonances at −105 ppm (Q³) and −115 ppm (Q⁴), showing 1:2 ratio of the relative intensity. The changes in NMR spectra indicate relaxation of Si—O—Si angles as well as condensation of SiO₄ tetrahedra. Interlayer strontium cations in the original crystalline AMH-3 are coordinated with oxygen atoms (O5, O10) which are connected to Q³ silicons (Si3, Si4, respectively). Each layer can be thought as being composed of two oxide sheets (sublayers) wherein Q⁴ atoms (Si2) in adjacent sublayers are bridged by oxygen (O₈).

Strong interaction involving strontium and sodium cations leads to different Si—O bond length for each of the crystallographically different oxygens as well as small Si—O—Si angles. Substitution of these cations upon swelling removes the structural restraints imposed on oxygen and silicon atoms, resulting in the increase of Si—O—Si angles and the shift of resonances in NMR spectra. In addition to the angular changes, it appears that substitution of sodium cations (Na₂) located in the layer space shortens the distance between two silanol groups related to Q³ silicons (Si₃, Si₄), leading to the interlayer condensation of some Q³ silicons and the generation of new Q⁴ units.

FIG. 10C is a SEM image of crystalline AMH-3 and shows well-defined plate-like crystals. In swollen AMH-3, the overall particle shape is retained (FIG. 10D). However, the well-defined compact shape of the crystalline material is lost. Instead of a flat surface, the swollen material reveals serrated edges which look like a stack of thin plates. Considering the unit cell dimension of AMH-3, it seems that the thickness of a single planar substructure is comparable to that of a few silicate layers. Each lamella runs parallel to the bc plane of the original crystal, i.e., the same plane that contains the original AMH-3 nanoporous layer. Details in the stratified substructure can be further examined by TEM imaging (FIG. 10D, inset). The dark contrast in the image corresponds to the layer of silicate, while the bright region is attributed to the organic surfactant molecules occupying interlayer space. It shows that each substructure shown in SEM imaging is composed of several silicate layers spaced by amine molecules. The ordered arrangement of silicate layers explains the appearance of new characteristic XRD peaks.

In swollen AMH-3 (FIG. 10D), the overall identity of microscopic particles is retained. However, the compact shape of the original crystals is lost. Instead of a well-defined flat surface, SEM imaging reveals serrated edges that look like a pile of plate-like substructures of nanometer scale. Considering the unit cell dimension of AMH-3, it seems that the thickness of a single planar substructure is comparable to that of a few silicate layers. These stratified substructures run parallel to the bc plane of the original crystal, i.e., the same plane that contains the original AMH-3 nanoporous layer.

In the TEM imaging (FIGS. 10E and 10F), the dark contrasts correspond to the silicate layers while the bright regions are attributed to the organic molecules occupying interlayer space. These images illustrate that each of the nanoscopic substructures shown in SEM imaging (FIG. 10D) consist of few silicate layers spaced by surfactant molecules. The ordered arrangement of silicate layers in each planar substructure explains the appearance of new characteristic XRD peaks in swollen AMH-3

The SEM and TEM data presented above show that AMH-3 swelling occurs without disintegration of the silicate layers. However, despite the mild conditions used for ionic exchange, the local order and connectivity of AMH-3 layers is not preserved since the Q³/Q⁴ ratio changes drastically. The well-defined compact shape of the original AMH-3 is no longer present. Each lamella runs parallel to the be plane of the original crystal, which contains the original AMH-3 nanoporous layer.

Specifically, it appears that this process involves major structural changes (i.e., it is not intercalation but “reactive swelling” as defined herein). The modelling results and consideration of the NMR data and IR data described herein suggest that the structural changes include change in bond angles and intralayer condensation of Q3 sites (i.e., sites that in the original crystalline AMH-3 belong to the same silicate layer and they are located at opposite faces of the silicate layer pointing in the gallery spaces). Such intralayer condensation would preserve the 8MR pores as limiting apertures for transport of molecules perpendicular to the layer thickness.

In summary, the swollen derivative of AMH-3 was prepared, for the first time, by reactive swelling (originally thought to be intercalation) of dodecylamine following proton exchange. The reactive swelling appears to be facilitated by the hydrogen bonding interaction between the layer surface silanol groups and the functional group of the primary amine. Emergence of the swollen structure is indicated by a series of new peaks in the X-ray diffraction as shown in FIG. 10B, implying bilayer configuration of the amine. SEM and TEM indicate that particle and layer integrity are preserved during the exchange and intercalation. However, the ²⁹Si MAS NMR (See FIGS. 12A and 12B) and the IR spectra (see FIG. 8B) suggest that major structural changes occurred during the swelling process, thus resulting in reactive swelling versus intercalation. In addition to the expected relaxation of strained Si—O—Si angles, an increase in the Q⁴/Q³ ratio suggests the condensation of SiOₜ tetrahedra, possibly taking place between Q³ tetrahedra located at opposite face of the silicate layer. Incorporation of swollen AMH-3 into a polymer matrix leads to the disappearance of characteristic peaks in the X-ray diffraction. Small angle X-ray scattering and transmission electron microscopy indicate that the nanocomposite contains globular nanoparticles as well as plate-like layers of nanoscale thickness, resulting in the formation of a mixed-matrix nanocomposite. The hydrogen/carbon dioxides' ideal selectivity of swollen AMH-3/PBI nanocomposite membrane is double that of the pure polymer.

FIG. 12A shows ²⁹Si solid-state MAS-NMR spectra of original AMH-3. FIG. 12B shows ²⁹Si solid-sate MAS-NMR spectra of swollen AMH-3. Structural changes involving different SiO₄ connectivity can be seen between the original and swollen AMH-3. For example, the Q³:Q⁴ ratio has changed from 3:1 to 1:3, indicating condensation of SiO₄ tetrahedra. Additionally, Q³ and Q⁴ peak positions have changed, indicating relaxation of Si—O—Si angles.

FIG. 12C shows FT-IR spectra of original and swollen AMH-3. In the swollen AMH-3, vibrational bands assigned to the Q³ external linkages (1150˜1050 cm⁻¹) are replaced by single broad band, while yielding new vibrational bands corresponding to the internal Si—O linkages (1300˜1150 cm⁻¹). Consistent with the NMR results, these changes suggest that some of the Q³ sites are condensed to Q⁴ species during these processes. The bands assigned to the S4Rs (650˜500 cm⁻¹) also show differences from those of original AMH-3, suggesting again that the connectivity of SiO₄ tetrahedra is subjected to substantial changes during the swelling process. Structural differences between original and swollen AMH-3 become more evident in the spectra between 4000 and 2500 cm⁻¹. Compared to the intensity around 3600 cm⁻¹ assigned to the lattice water, the absorption bands with maxima below 3440 cm⁻¹ are attributed to dimers of —OH groups involved in hydrogen bonding between adjacent layers. In the swollen AMH-3, these absorption bands are no longer noticeable. Instead, strong absorption is shown from dodecylamine molecules around 2920 and 2850 cm⁻¹, corresponding to the C—H stretching of —CH₂— aliphatic chains and CH₃, respectively. These results suggest that silicate layers in swollen AMH-3 are not coupled by hydroxyl dimers, but packed with surfactant molecules as evidenced by XRD results.

FIG. 13 shows a structural model for original AMH-3 and probable structural models of two different swollen structures, i.e., “A” and “B,” projected along the a-axis and c-axis. Oxygen atoms are indicated in dark lines, silicon atoms are indicated in light lines and hydrogen atoms are indicated with while spheres. As described herein, it is thought that the swollen AMH-3 produced is a combination of structure “A” and “B.”

The proposed structural models shown in FIG. 13 are based on the NMR and XRD results. Specifically, the ²⁹Si solid-state NMR gave information regarding SiO₄ connectivity in terms of Q³:Q⁴ ratio (from the peak intensity) and Si—O—Si angles (from the position of peaks). The NMR from the crystalline, charge-balanced framework of original AMH-3 presented unusual structure compared to other layered silicate. Firstly, the number of Q³ silicon atoms is higher (Q³:Q⁴=3:1) than usual layered silicate (Q³:Q⁴=1:3). Secondly, the requirements of charge-balanced structure with gallery cations (Na, Sr) lead to the larger Si—O—Si angle than usual, which means there is structural constraint in the original AMH-3 framework. On the other hand, the NMR of swollen AMH-3 showed 1:2.6 of Q³:Q⁴ ratio along with the Si—O—Si angles of usual layered silicate. The changes of Q³:Q⁴ ratio indicated that the condensation of Q³ species occurred during swelling process. The 4 MRs in the original AMH-3 structure consist of four Si atoms: Si₁, Si₂, Si₃, and Si₄. Si₂ atoms are connected to each other to make Q⁴ species and it is considered that a substantial fraction of them cannot be disconnected during swelling process under the mild conditions used. The remaining three Si atoms leads to Q³ species, where Si₃ and Si₄ are crystallographically identical. Therefore, each Si₁ atom has two possible connections: Si₁ to Si₃(Si₄), or Si₁ to Si₁. The first case leads to the proposed structure “B,” having Q³:Q⁴ ratio of 1:3. In the second case, Si₃ and Si₄ atoms remains uncondensed and make the structure “A,” having 1:1 Q³:Q⁴ ratio. Each case was simulated with Cerius2 and energy-minimized to check the angles and the bond lengths are reasonable.

Both proposed swollen structures, i.e., “A” and “B,” shown in FIG. 10, have crystalline structures. From the XRD results shown in FIGS. 10a and 10b, it is known that the structure of swollen AMH-3 is that of an amorphous-like structure, implying that the swollen AMH-3 structure is built from the disorded combination of structure “A” and “B.” The Q³:Q⁴ ratio of 1:2.6 from NMR also suggested that the swollen AMH-3 structure is not from the structure “B” only. It is likely that the experimental Q3:Q4 ratio could be explained if the ratio of structure “A” and “B” in swollen AMH-3 is around 1:8.

### Example 3

### Preparation of Nanocomposite Materials

For the two (2) wt % swollen AMH-3 nanocomposite membrane, 0.012 g of swollen AMH-3 was dispersed in 5.31 g of dimethylacetamide (99.8%, Aldrich) followed by successive addition of 0.7 g of dilute PBI (polybenzimidazole) solution (7.5 wt % PBI in 92.5 wt % dimethylacetamide). After two hours of vigorous stirring at 373 K, 2.72 g of 20 wt % PBI solution was added and further stirred at the same temperature for two hours. The mixture was cooled down to room temperature and sonicated for one hour. The mixture was poured on a glass plate and cast using a doctor's blade. The glass plate was covered to prevent dust and heated in an oven at 333 K for 4 hours to ensure the evaporation of solvents. Membranes of approximately 30 μm thickness were peeled off from the glass plate using small amount of deionized water. The membranes were annealed by heating under vacuum in cyclic manner between 323 K and 553 K four times.

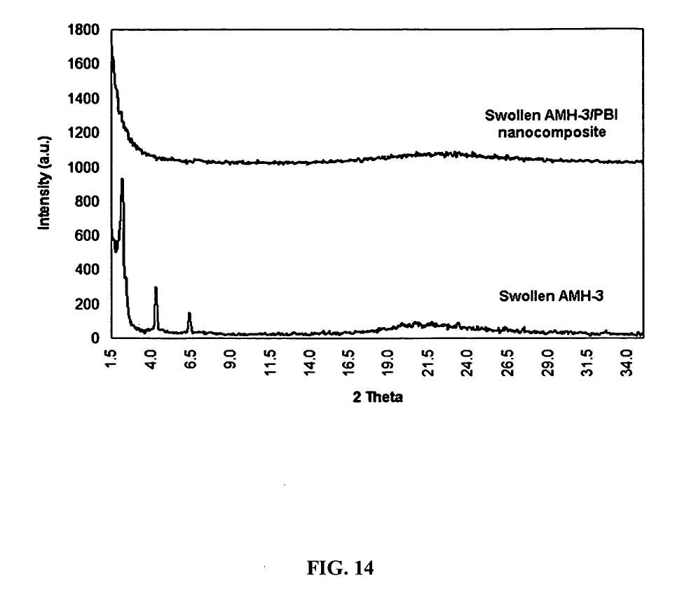

A low-permeability material, polybenzimidazole (PBI), was chosen as a continuous phase due to its promise for use in membranes for fuel cells and gas separation. In order to enhance the dispersion of swollen AMH-3, a priming technique was introduced in addition to the solution ionic exchange method. The priming technique involved initially adding only small amounts of polymer into the silicate-containing suspension, rather than adding the entire amount of polymer at once. The microstructure of prepared composites was characterized by XRD, SAXS, and TEM. In terms of X-ray diffraction shown in FIG. 14, the characteristic peaks of swollen AMH-3 disappear by mixing with PBI.

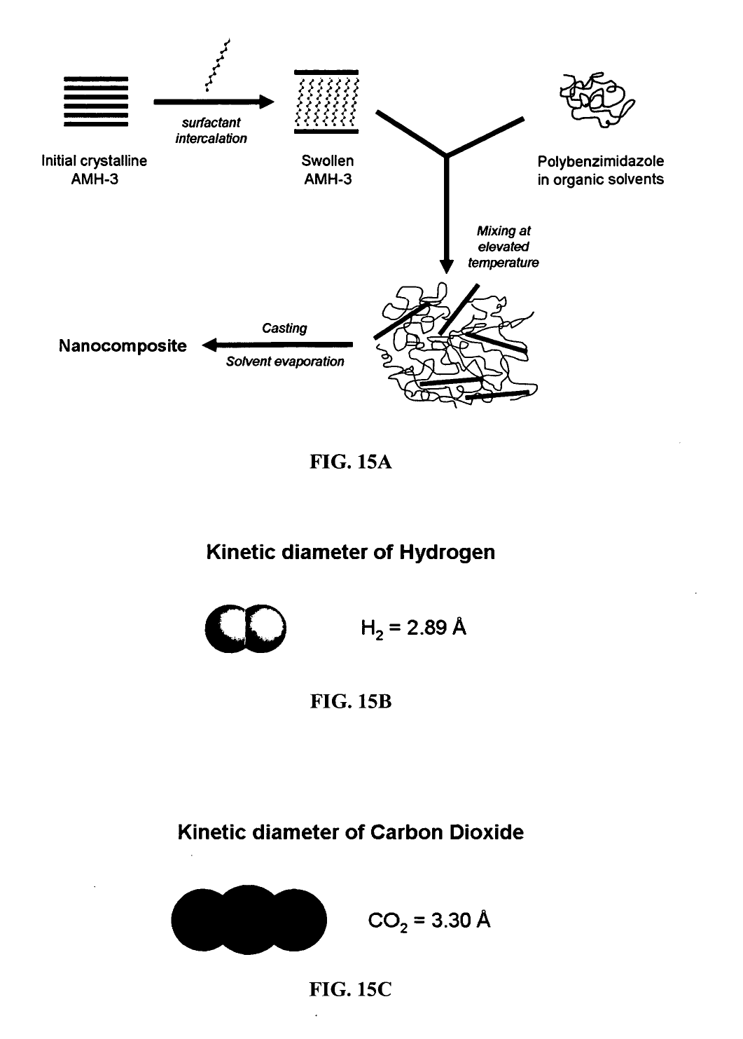

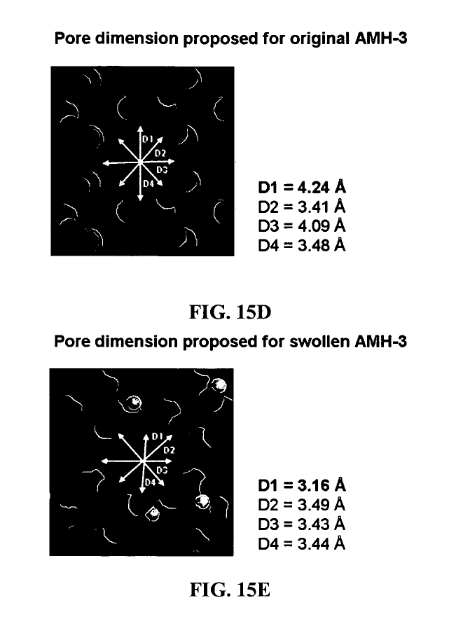

A schematic of the fabrication of a polymer/swollen AMH-3 nanocomposite is shown in FIG. 15A. The method involves dispersion of nanoporous layers for the gas-selective membrane using a solution reactive swelling method together with a priming technique.

Kinetic diameters of hydrogen and carbon dioxide are shown in FIGS. 15B and 15C, respectively. Pore dimension after subtraction of oxygen ionic diameter of the original AMH-3 and the swollen material (Structure “B”) are shown in FIGS. 15D and 15E, respectively. A comparison between FIGS. 15B/15C and FIGS. 15D/15E suggests that the pore dimension of the swollen material (3.16 A) is possibly in the range between the kinetic diameter of hydrogen (2.89 A) and carbon dioxide (3.30 A). This estimation suggests that swollen AMH-3 material may present molecular sieving ability with respect to hydrogen and carbon dioxide. This conclusion is supported by the experimental results showing the selectivity improvement in swollen AMH-3 nanocomposite membranes.

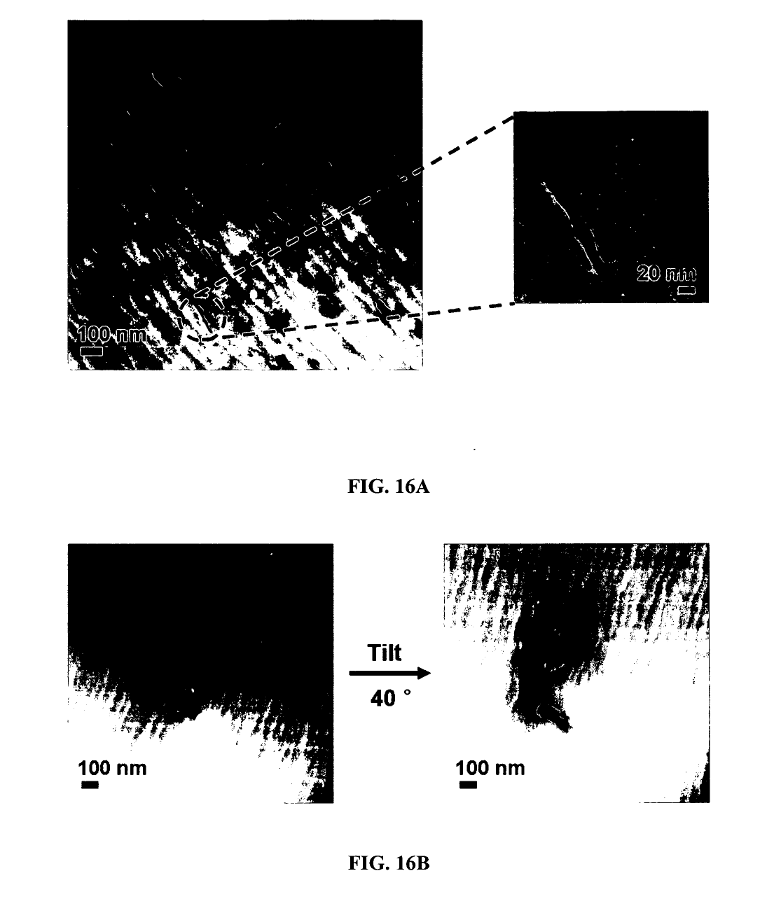

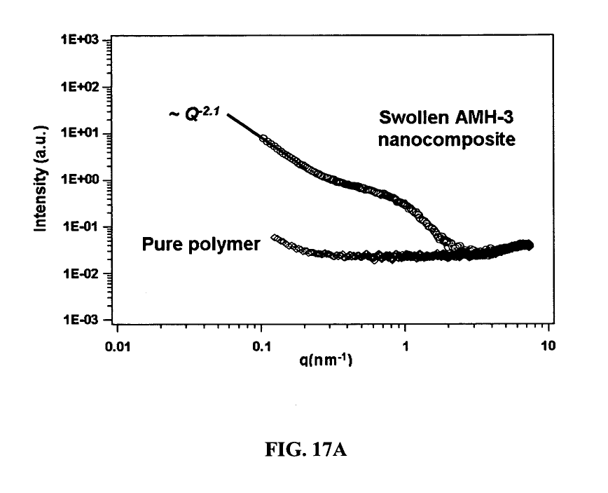

A cross-sectional TEM (i.e., structural investigation from real space) of a nanocomposite membrane is shown in FIG. 16A. Plate-like layers with small spherical particles are visible in this image. The cross-sectional TEM images are tilted by 40° in FIG. 16B.

FIG. 17A provides SAXS spectra (i.e., structural investigation from reciprocal space) showing the model fit (solid line) to the experimental data of pure PBI and three (3) wt % swollen AMH-3 nanocomposite (symbols). Consistent with the XRD data, sharp Bragg peaks from swollen AMH-3 are not observed in the high-q region, implying the possibility of mostly exfoliated platelets in the continuous phase.^{[25]} On the other hand, the spectra reveal different q dependences over the q ranging from 0.1 to 5 nm⁻¹, which may be explained by the presence of at least two different particle morphologies in the nanocomposite. The Q⁻² dependence in low q region suggests the presence of plate-like particles, possibly exfoliated layers.

The intensity, I(q), from the SAXS experiments is a function of multiple variables regarding the interactions, structure, and shape of particles: information of the particle shape is related to the form factor, P(q), while that of the particle interactions is included in the structure factor, S(q). For the condition of dilute solutions as studied here, particle interactions can be assumed to be negligible, i.e., S(q)=1. The shape of the nanoparticles was evaluated by the model fit of experimental data with various geometrical form factors such as spheres, cylinders, ellipsoids, lamellas, and stacked disks, using the software provided by the National Institute of Standards and Technology. However, the spectra from swollen AMH-3 nanocomposite could not be fitted by the single form factor alone. The best overall fit to the experimental data was found in the model of exfoliated monodisperse disks coexistent with the spheres with Gaussian size distribution. The high-q region of patterns, showing the peak at approximately one (1) nm⁻¹, could be fit by spherical form factor having the mean radius of approximately 1.5 nm. The form factor analyses also show that the low-q region can be modeled with individual disk-like particles, i.e., platelets, assuming approximately one (1) nm thickness and approximately 50 nm radius. A q^{-2.1} dependence in the Guinier region, along with disappearance of Bragg peaks, suggest that some portion of the swollen AMH-3 are present in the form of exfoliated platelets. Small deviations of slope from the theoretical value (q⁻²) may arise from stacking of platelets and/or interference effects of interparticle interactions.

Consistent with the form factor analyses of SAXS spectra, cross-sectional TEM imaging of the nanocomposite films displays anisotropic morphologies of nanoparticles, containing plate-like and globular particles (FIG. 17B). It also shows that nanoparticles are randomly-oriented throughout the continuous phase with size distribution. Some of the particles over 100 nm observed in TEM are thought to be either a flat surface of platelets or a big globular particle which cannot be detected by our SAXS instrument (SAXSess, Anton-Paar) having limitation on the minimum q values of 0.1 nm⁻¹. The SAXS and TEM data presented above show that the microstructure of nanocomposite film can be best described if it contains exfoliated layers of nanoscale thickness as well as globular particles with size distribution. SAXS data is subject to alternative interpretations. Therefore, the high “q” area of the spectra should not be limited to any one proposed theory. The low “q” area, however, does indicate plate-like high aspect ratio particles that may be interpreted as exfoliated or nearly-exfoliated particles.

### Example 4

The separation factor of swollen AMH-3 nanocomposite membranes prepared in Example 1 was evaluated in terms of the hydrogen/carbon dioxide ideal selectivity at various temperatures. FIGS. 17C-17E summarize the single-gas permeation results of hydrogen/carbon dioxide ideal selectivity as a function of hydrogen permeability (in Barrer) for pure PBI membranes (PBI1) from U.S. Patent Application Publication No. US2004/0261616, entitled, “Cross-linked Polybenzimidazole Membrane for Gas Separation,” (Dec. 30, 2004) with membranes prepared as described herein (PBI₂). PBI with dodecylamine (PBI₃), 14 wt % proton-exchanged AMH-3/PBI mixed matrix composites (P₁, P₂), three (3) wt % (S₁) and two (2) wt % (S₂) swollen AMH-3/PBI nanocomposites at 35° C., 100° C. and 200° C., respectively.

FIG. 17C summarizes the results from the single-gas permeation experiments for these membranes measured at 35° C. As can be seen, both composite membranes (i.e., the proton-exchanged or swollen AMH-3 composite membranes as described above) exhibited permeability reduction similar to conventional polymer-layered silicate composites. This permeability reduction is likely due to the large aspect ratio of the silicates increasing the tortuosity of the gas transport path. However, unlike typical PLS composites which show barrier properties for all gas species regardless of the molecule size, these membranes show more permeability reduction for carbon dioxide compared to that of hydrogen. The behavior of these membranes showing different permeability reduction for each gas species resembles that of the molecular sieves showing an ability of molecular recognition based on the size of penetrant. As a result of divergence in permeability reduction, the H₂/CO₂ ideal selectivity of theses membranes showed substantial increase, by more than a factor of two, compared to pure PBI membranes (PBI1, PBI2). The improvement of performance likely cannot be attributed to the organic surfactant alone, because a PBI membrane with the same amount of dodecylamine shows similar performance with the pure polybenzimidazole membrane. The improvement may be due, in part, to the molecular sieving action of the silicate additive and/or the modification of the polymer properties at the polymer/silicate interfaces.

Both types of composite membranes also revealed a similar level of selectivity enhancements. Specifically, a nanocomposite with only three (3) wt % of swollen AMH-3 (S1) showed a H₂/CO₂ ideal selectivity comparable to the composites containing 14 wt % proton-exchanged AMH-3 (P1). The selectivity improvement observed in the nanocomposite membranes with a reduced amount of selective phase can be attributed to the particle exfoliation increasing the tortuosity of the transport path as well as the accessibility to the pore system.

The composite membranes in FIGS. 17D and 17E revealed larger permeability decrease of carbon dioxide than that of hydrogen, resulting in the improvement of membrane selectivity. In general, as the operating temperature becomes higher than 35° C., these membranes present an increase in permeability for both gas species, i.e., for H₂ and CO₂. As a result, at the operating temperatures higher than 100° C., the CO₂ permeability reduction approached that of hydrogen. As a consequence, improvements of the ideal selectivity achieved at 35° C. (FIG. 17C) were no longer observed, resulting in a comparable selectivity to that of the pure polymer. This may be attributed to the mismatch of the transport properties between continuous phase (PBI) and selective components at these temperatures.

### Example 5

FIGS. 18A and 18B shows the TEM micrographs of swollen AMH-3 produced with the priming process performed at 100° C. as described in Example 3. Samples were prepared by drying a few drops of the priming solution on the copper grids and characterized by TEM. Similar to the reticular nanoparticles observed in the cross sectional TEM images of nanocomposite membranes, these TEM images show the presence of nanoscale particles fragmented from swollen AMH-3. It suggests that, during the priming process at the elevated temperature, stacked assembly of the swollen AMH-3 layers is disjoined and fragmented, resulting in the significant reduction of the particle dimension from micrometer range to nanometer scale.

In another procedure, room temperature conditions were used. In this instance the room temperature was 25° C. In this experiment, the reaction proceeded for two hours, with stirring, in the presence of dilute PBI solutions. TEM samples of the reaction products were prepared by drying a few drops of the solution on the TEM grids and characterized. FIGS. 18C and 18D show TEM images of swollen AMH-3 after priming at room temperature. As can be seen, nanoscale components of swollen AMH-3 are possible, even with a priming reaction performed at room temperature.

FIG. 19 shows small angle neutron scattering (SANS) spectra of the dilute solution of PBI in DMAc (0.7 g of 7.5 wt % PBI solution in 5.31 g of DMAc) and swollen AMH-3 samples dispersed in dilute PBI solution at the room temperature conditions, in which the amount of polymers were varied by 0.05, 0.1, 0.3, and 0.7 g, respectively. Emergence of nanoscale moieties facilitated by the room-temperature processing can be monitored by tracing the changes of SANS intensities in the q range of approximately 0.01 to 0.1 Å⁻¹. In this region, the SANS spectra of the dilute PBI solution does not show significant signals, while those of the swollen AMH-3 dispersions present a gradual increase of intensities as the amounts of polymer is increased. For example, a swollen AMH-3 sample mixed with 0.7 g of PBI solution reveals the presence of a broad hump in this region possibly due to the scattering from the nanoparticle population during the room-temperature blending. A maximum value of this broad hump can be estimated around 0.02 Å⁻¹ approximately, which corresponds to the mean particle size of ca. 30 nm.

Conversely, the absence of a clear maximum suggests these particles have broad size distributions. These spectra indicate that nanoscale particles may be populated by mixing with polymer solutions at room temperature conditions, as evidenced in previous TEM micrographs. The slope of this intensity in the low q region (<0.01 Å⁻¹) shows a dependence of q to the −1.8, which suggests these particles are in the shape of thin, plate-like particles as indicated in the low-q intensities of nanocomposite membranes.

### CONCLUSION

The novels methods and materials discussed herein, provide, for the first time, proton-exchanged and swollen proton-exchanged layered silicate materials useful in a variety of applications. The swollen materials produced by reactive swelling are surprisingly new swollen materials with one or more major changes of the layer structure, rather than a simple intercalated phase. These materials may be further processed by exfoliation. Any of the aforementioned materials may be combined with a polymer to produce nanocomposite membranes having nanoparticles with improved H₂/CO₂ selectivity. The nanoparticles are well-dispersed but randomly oriented within the polymer matrix. There is the further possibility of further improvements in performance with alignment of single exfoliated layers.

All of the publications, patents and patent documents cited are incorporated by reference herein, each in their entirety, as though individually incorporated by reference. In the case of any inconsistencies, the present disclosure, including any definitions therein, will prevail.

Although specific embodiments have been illustrated and described herein, it will be appreciated by those of ordinary skill in the art that any procedure that is calculated to achieve the same purpose may be substituted for the specific embodiments shown. This application is intended to cover any adaptations or variations of the present subject matter. For example, rather than substantially homogeneous thin film membranes, the novel materials described herein may also be used in hollow fiber (cylindrical) membranes and asymmetric hollow fiber membranes having a thin skin over a porous sublayer. Therefore, it is manifestly intended that embodiments of this invention be limited only by the claims and the equivalents thereof.

1. A method comprising:
with an amino acid as a buffer, exchanging one or more cations from a location in between adjoining layers of a layered silicate material with one or more protons to produce a proton-exchanged layered silicate material, the proton-exchanged layered silicate material comprising at least two layers, wherein:
each of the at least two layers includes a plurality of tetrahedral SiO₄ units,
each of the at least two layers further includes a first plurality of channels extending from a top side of the layer to a bottom side of the layer,
each channel in the first plurality of channels is defined by an X-membered ring, where X is an integer and is the same for each channel, and
each of the at least two layers further includes a second plurality of channels extending essentially parallel to the top side of the layer.

2. The method of claim 1 wherein the one or more protons are exchanged with one or more strontium cations, one or more sodium cations, or a combination thereof, the one or more strontium and sodium cations located in the layered silicate material.

3. The method of claim 1 wherein X=8.

4. The method of claim 1 wherein the amino acid is DL-histidine.

5. The method of claim 1 wherein the amino acid is glycine, L-alanine or L-tryptophane.

6. The method of claim 1 wherein the proton-exchanged layered silicate material further contains a monovalent cation.

7. (canceled)

8. The method of claim 1 wherein the proton-exchanged layered silicate material further contains an element having catalytic properties.

9. (canceled)

10. The method of claim 1 further comprising combining the proton-exchanged layered silicate with a polymer.

11. The method of claim 1 further comprising exfoliating the proton-exchanged layered silicate material to produce stacks containing fewer individual layers than in the layered silicate material.

12. (canceled)

13. The method of claim 1 wherein the method further comprises performing reactive swelling of the proton-exchanged layered silicate material with a non-charged primary amine to produce a swollen proton-exchanged layered silicate material, wherein layers of the layered silicate material have a first structure and layers of the swollen proton exchanged layered silicate have a second structure, wherein the layers of the swollen proton-exchanged layered structure have major structural differences as compared with the layers of the layered silicate material.

14. The method of claim 13 wherein the step of reactive swelling occurs prior to completion of the step of exchanging one or more cations.

15. The method of claim 13 wherein the non-charged primary amine is dodecylamine having 12 carbons.

16. The method of claim 13 wherein the non-charged primary amine has more than 12 carbons.

17. The method of claim 13 wherein the non-charged primary amine is tetradecylamine (C14), hexadecylamine (C16), or octadecylamine (C18).

18. The method of claim 13 further comprising pillaring the swollen proton-exchanged layered silicate material to produce a pillared material.

19. The method of claim 13 further comprising combining the swollen proton-exchanged layered silicate material with a polymer.

20. The method of claim 13 further comprising exfoliating the swollen proton-exchanged layered silicate material to produce stacks containing fewer individual layers than in the layered silicate material.

21-29. (canceled)

30. A product comprising:
at least one layer of a proton-exchanged layered silicate material, each layer including a plurality of tetrahedral SiO₄ units and a first plurality of channels extending from a top side of the layer to a bottom side of the at least one layer,
wherein each channel in the first plurality of channels is defined by an X-membered ring, where X is an integer and is the same for each channel, the at least one layer further including a second plurality of channels extending essentially parallel to the top side of the at least one layer.

31. The product of claim 30 comprising more than one layer.

32. The product of claim 30 wherein X=8.

33. The product of claim 30 wherein the layered silicate material further contains a monovalent cation.

34. The product of claim 30 wherein the proton-exchanged layered silicate material further contains an element having catalytic properties.

35. A product comprising:
at least one layer of a swollen proton-exchanged layered silicate material, each layer including a plurality of tetrahedral SiO₄ units and a first plurality of channels extending from a top side of the layer to a bottom side of the layer,
wherein each channel in the first plurality of channels is defined by an X-membered ring, where X is an integer and is the same for each channel, the at least one layer further including a second plurality of channels extending essentially parallel to the top side of the at least one layer.

36. The product of claim 35 comprising more than one layer.

37-44. (canceled)
